(19) United States
(12) Patent Application Publication
(10) Pub. No.: US 2026/0025599 A1
(43) Pub. Date: Jan. 22, 2026

(54) IMAGE SENSOR DEVICE AND OPERATION METHOD THEREOF

(71) Applicant: Samsung Electronics Co., Ltd., Suwon-si (KR)

(72) Inventor: Jungwook Lim, Suwon-si (KR)

(21) Appl. No.: 19/187,049

(22) Filed: Apr. 23, 2025

(30) Foreign Application Priority Data
Jul. 22, 2024 (KR) 10-2024-0096270

(51) Int. Cl. H04N 25/77; H04N 25/42

(52) U.S. Cl. CPC H04N 25/77; H04N 25/42

(57) ABSTRACT

An image sensor device includes a first pixel including: a small reset gate electrically connected between a 0-th node and a reset power, first to fourth small sub-pixels that are electrically connected to the 0-th node and respectively include small photodiodes, a connect switch electrically connected between the 0-th node and a large floating diffusion node, first to fourth large sub-pixels that are electrically connected to the large floating diffusion node and respectively include large photodiodes, where a light receiving area of each of the large photodiodes is greater than a light receiving area of each of the small photodiodes, a source follower that is electrically connected between a pixel power and a first node and is configured to operate in response to a voltage of the large floating diffusion node, and a select gate electrically connected between the first node and the first column line.

### CROSS-REFERENCE TO RELATED APPLICATIONS

This application claims priority under 35 U.S.C. § 119 to Korean Patent Application No. 10-2024-0096270 filed on Jul. 22, 2024, in the Korean Intellectual Property Office, the disclosures of which are incorporated by reference herein in their entireties.

### TECHNICAL FIELD

Embodiments of the present disclosure described herein relate to an image sensor, and more particularly, relate to an image sensor device and an operation method thereof.

### BACKGROUND

An image sensor obtains image information about an external object by converting a light reflected from the external object into an electrical signal. An electronic device, which includes the image sensor, may display an image in a display panel by using the obtained image information.

The image sensor may be mounted in various types of electronic devices. For example, the electronic device, which includes the image sensor, may be included as a component of various types of electronic devices, such as a smartphone, a tablet personal computer (PC), a laptop PC, and a wearable device.

The image sensor may support various functions for providing various user experiences to the user. As an example, the image sensor may be mounted in an autonomous driving system and may provide various image information for autonomous driving of a vehicle, such as an obstacle or a traffic signal in front of the vehicle. In this case, when the quality of the image obtained from the image sensor is reduced (e.g., the quality of the image is reduced due to a flicker phenomenon or motion blur), the operation of the vehicle may be undesirable. Accordingly, it may be desirable to provide an image sensor having a high dynamic range (HDR) of a high level.

### SUMMARY

Embodiments of the present disclosure provide an image sensor device with improved performance and an operation method thereof.

According to some embodiments, an image sensor device includes a first pixel electrically connected to a first column line, where the first pixel includes: a small reset gate electrically connected between a 0-th node and a reset power, a first small sub-pixel, a second small sub-pixel, a third small sub-pixel, and a fourth small sub-pixel that are electrically connected to the 0-th node and respectively include small photodiodes, a connect switch electrically connected between the 0-th node and a large floating diffusion node, a first large sub-pixel, a second large sub-pixel, a third large sub-pixel, and a fourth large sub-pixel that are electrically connected to the large floating diffusion node and respectively include large photodiodes, where a light receiving area of each of the large photodiodes is greater than a light receiving area of each of the small photodiodes, a source follower that is electrically connected between a pixel power and a first node and is configured to operate in response to a voltage of the large floating diffusion node, and a select gate electrically connected between the first node and the first column line.

According to some embodiments, an image sensor device includes a first pixel electrically connected to a first sub-column line and a second sub-column line, where the first pixel includes: a small reset gate electrically connected between a 0-th node and a reset power, a first small sub-pixel, a second small sub-pixel, a third small sub-pixel, and a fourth small sub-pixel that are electrically connected to the 0-th node and respectively include small photodiodes, a small source follower that is electrically connected between a pixel power and a first node and is configured to operate in response to a voltage of the 0-th node, a small select gate electrically connected between the first node and the first sub-column line, a first large sub-pixel, a second large sub-pixel, a third large sub-pixel, and a fourth large sub-pixel that are electrically connected to a large floating diffusion node and respectively include large photodiodes, where a light receiving area of each of the large photodiodes is greater than a light receiving area of each of the small photodiodes, a large source follower that is electrically connected between the pixel power and a second node and is configured to operate in response to a voltage of the large floating diffusion node, and a large select gate electrically connected between the second node and the second sub-column line.

According to some embodiments, an operation method of an image sensor device which includes a first pixel including a plurality of small sub-pixels and a plurality of large sub-pixels including a large floating diffusion node includes generating first pixel signals corresponding to charges generated by small photodiodes of the plurality of small sub-pixels and large photodiodes of the plurality of large sub-pixels, where a light receiving area of the large photodiodes is greater than a light receiving area of the small photodiodes, and generating a second pixel signal corresponding to a sum of charges generated by the large photodiodes.

### BRIEF DESCRIPTION OF THE FIGURES

The above and other objects and features of the present disclosure will become apparent by describing in detail embodiments thereof with reference to the accompanying drawings.

FIG. 1 is a diagram illustrating an image system according to some embodiments of the present disclosure.

FIG. 2 is a block diagram illustrating an image sensor device of FIG. 1.

FIG. 3 is a circuit diagram illustrating an example of a unit pixel group of FIG. 2.

FIG. 4A is a circuit diagram for describing a small sub-pixel of FIG. 3.

FIG. 4B is a circuit diagram for describing a large sub-pixel of FIG. 3.

FIGS. 5A and 5B are diagrams for describing an example of a readout operation of an image sensor device of FIG. 2.

FIGS. 6A, 6B, and 6C are timing diagrams for describing a normal readout operation and a binning mode readout operation of FIG. 5A.

FIG. 7 is a circuit diagram illustrating another example of a unit pixel group of FIG. 2.

FIGS. 8A and 8B are timing diagrams for describing a readout operation on a pixel of FIG. 7.

FIG. 9 is a diagram illustrating a layout of a pixel of FIG. 2.

FIGS. 10A, 10B, and 10C are diagrams for describing a micro lens of a pixel.

FIGS. 11A and 11B are circuit diagrams for describing other examples of a unit pixel group of FIG. 2.

FIG. 12 is a diagram for describing an operation method of an image sensor device according to some embodiments of the present disclosure.

FIG. 13 is a diagram for describing operation S120 of FIG. 12 in detail.

FIG. 14 is a diagram for describing operation S130 of FIG. 12 in detail.

FIG. 15 is a diagram illustrating an image sensor device according to some embodiments of the present disclosure.

FIG. 16 is a diagram illustrating an autonomous driving system to which an image sensor device according to some embodiments of the present disclosure is applied.

### DETAILED DESCRIPTION

Below, embodiments of the present disclosure will be described in detail and clearly to such an extent that an ordinary one in the art easily carries out the present disclosure.

To clarify the present disclosure, parts that are not connected with the description will be omitted, and the same elements or equivalents are referred to by the same reference numerals throughout the specification. Further, since sizes and thicknesses of constituent members shown in the accompanying drawings are arbitrarily given for better understanding and ease of description, the present disclosure is not limited to the illustrated sizes and thicknesses. In the drawings, the thickness of layers, films, panels, regions, etc., are exaggerated for clarity. In the drawings, for better understanding and ease of description, thicknesses of some layers and areas are excessively displayed.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

In addition, unless explicitly described to the contrary, the word “comprises”, and variations such as “comprises” or “comprising”, will be understood to imply the inclusion of stated elements but not the exclusion of any other elements. As used herein, the phrase “at least one of A, B, and C” refers to a logical (A OR B OR C) using a non-exclusive logical OR, and should not be construed to mean “at least one of A, at least one of B and at least one of C.” As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements and/or components, but do not preclude the presence or addition of one or more other features, steps, operations, elements, components and/or groups thereof. The term “and/or” includes any and all combinations of one or more of the associated listed items. The term “connected” may be used herein to refer to a physical and/or electrical connection and may refer to a direct or indirect physical and/or electrical connection. The terms “first,” “second,” etc. may be used herein to merely distinguish one component, element, etc., from another.

In the specification, function blocks of drawings, which respectively correspond to the terms “block”, “unit”, “logic”, etc., may be implemented in the form of software, hardware, or a combination thereof.

The present disclosure has been described herein with reference to flowchart and/or block diagram illustrations of methods, systems, and devices in accordance with exemplary embodiments of the present disclosure. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, are configured to implement the functions specified in the flowchart and/or block diagram block or blocks.

These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

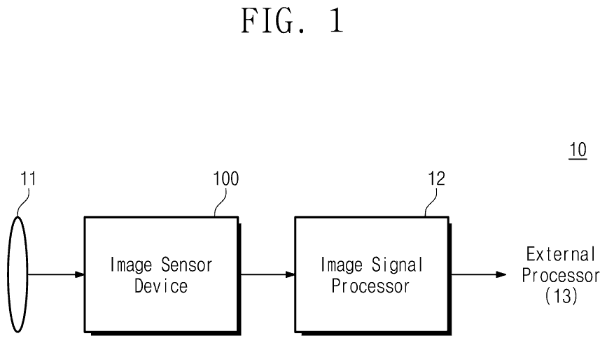

FIG. 1 is a diagram illustrating an image system according to some embodiments of the present disclosure. Referring to FIG. 1, an image system 10 may include a lens 11, an image sensor device 100, and an image signal processor 12. In some embodiments, the image system 10 may be implemented as a part of various electronic devices, such as a camera, a smartphone, a wearable device, an Internet of Things (IoT) device, home appliances, a tablet personal computer (PC), a personal digital assistant (PDA), a portable multimedia player (PMP), a navigation system, a drone, an advanced drivers assistance system (ADAS), a traffic camera, and a CCTV. Also, the image system 10 may be installed in an electronic device which is provided as a part of a vehicle, furniture, manufacturing equipment, a door, and various kinds of measuring instruments.

The lens 11 may receive a light reflected from an external object. The image sensor device 100 may generate an electrical image signal, based on the light received through the lens 11. For example, the image sensor device 100 may be implemented with a complementary metal oxide semiconductor (CMOS) image sensor. However, the present disclosure is not limited thereto. For example, the image sensor device 100 may be implemented based on various image sensors such as a dynamic vision sensor (DVS) and a digital pixel sensor (DPS).

The image signal processor 12 may receive electrical signals (e.g., image data or output data including information about the external object or the front view) from the image sensor device 100 and may perform various image signal processing operations on the received signals. In some embodiments, the image signal processing operations may include various signal processing operations for improving the quality of image, such as a de-noising operation, a tone mapping operation, a detail enhancing operation, a white balancing operation, a gamma correction, a remosaic operation, a de-mosaic operation, a sharpening operation, and a color conversion operation. In some embodiments, the image signal processor 12 may perform the remosaic operation for generating an image of the Bayer pattern by using image data associated with a full-mode readout operation, which are received from the image signal processor 12. For example, the image signal processor 12 may convert image data of the Tetra-Bayer pattern to image data of the Bayer pattern through the remosaic operation. The full-mode readout operation will be described with reference to the following drawings.

Image signals (e.g., signals experiencing the image processing operation on image data) which are output from the image signal processor 12 may be transmitted to an external processor 13. The external processor 13 may merge the received image signals to generate a high dynamic range (HDR) image. However, the present disclosure is not limited thereto. The external processor 13 may be included in the image signal processor 12.

In some embodiments, the image sensor device 100 may include a plurality of pixels. Each of the plurality of pixels may include a plurality of sub-pixels. In some embodiments, the plurality of sub-pixels may be disposed in the shape of the Tetra-Bayer pattern. Each of the plurality of sub-pixels may have a split photodiode structure. That is, each of the plurality of sub-pixels may include a large photodiode and a small photodiode. In this case, large photodiodes included in one pixel may share one floating diffusion node (e.g., the large photodiodes included in one pixel may be electrically connected to a common floating diffusion node). As used herein, “large photodiode” refers to a photodiode having a relatively larger or wider light receiving surface area, and “small photodiode” refers to a photodiode having a relatively smaller or narrower light receiving surface area.

In some embodiments, the image sensor device 100 may perform the readout operation on pixels to generate image data. In this case, the readout operation may include the full-mode readout operation and a binning mode readout operation.

The full-mode readout operation may include a plurality of readout operations for respective sub-pixels included in a pixel. In this case, the plurality of readout operations may be performed based on a conversion gain mode of each sub-pixel.

The binning mode readout operation may mean the readout operation, which is based on all the large photodiodes, in a low conversion gain mode. As the binning mode readout operation is performed, the sufficient amount of light may be received even in a low-illuminance environment. Accordingly, according to the present disclosure, the HDR of the image sensor device 100 may be easily implemented. A structure and an operation of the image sensor device 100 according to some embodiments of the present disclosure will be described in detail with reference to the following drawings.

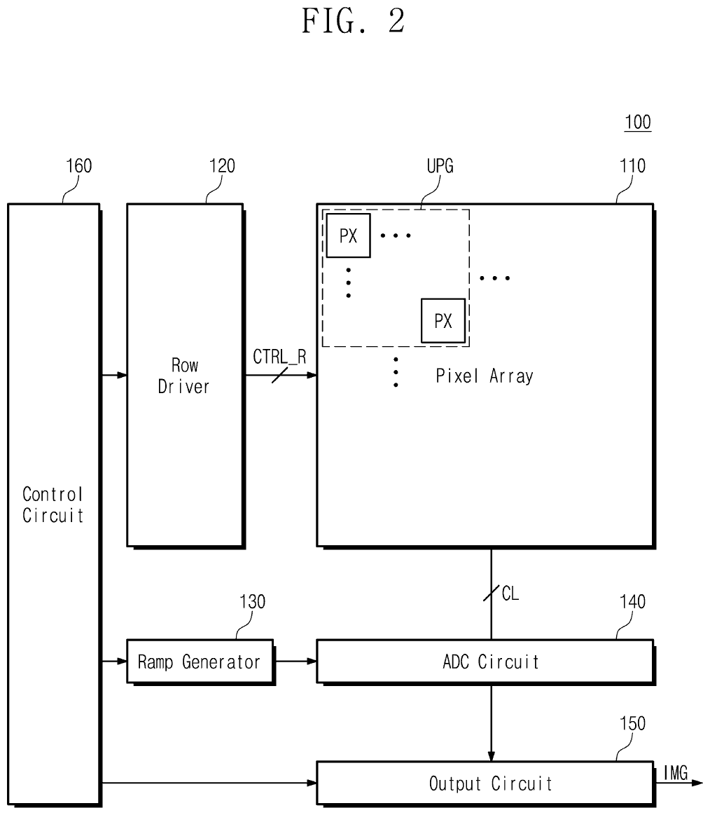

FIG. 2 is a block diagram illustrating an image sensor device of FIG. 1. Referring to FIGS. 1 and 2, the image sensor device 100 may include a pixel array 110, a row driver 120, a ramp signal generator 130, and analog-to-digital converter (ADC) circuit 140, an output circuit 150, and a control circuit 160.

The pixel array 110 may include a plurality of pixels arranged along rows and columns. In response to control signals CTRL_R received from the row driver 120, the plurality of pixels may convert the light received from the outside into electrical signals and may output the converted electrical signals through a plurality of column lines CL. In some embodiments, a row may indicate a pixel row in which a plurality of pixels are arranged, and a column may indicate a pixel column in which a plurality of pixels are arranged.

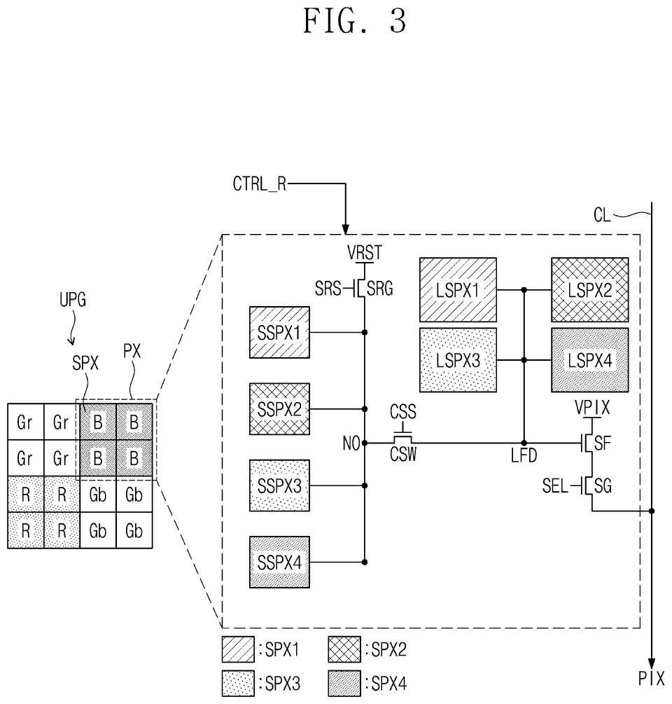

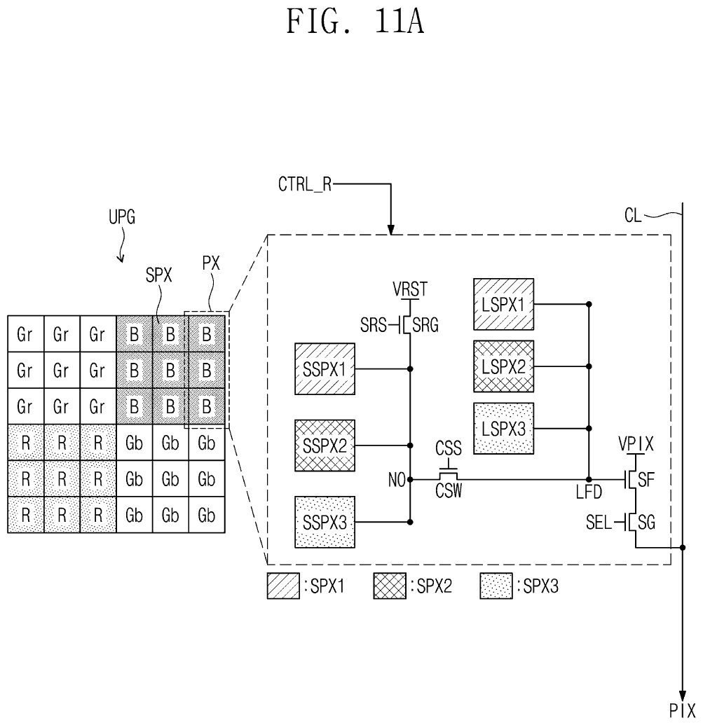

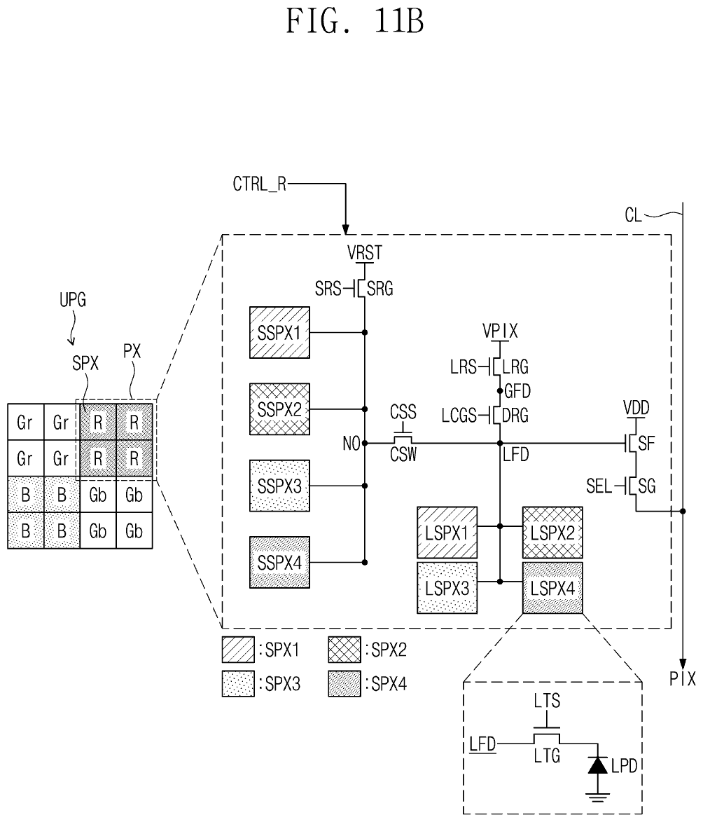

The pixel array 110 may be divided into a plurality of unit pixel groups UPG, each unit pixel group UPG may include a plurality of pixels PX, and each of the plurality of pixels PX may include a plurality of sub-pixels. In some embodiments, the unit pixel group UPG may mean a pixel group of a minimum unit by which the same color patterns are repeated. For example, when the pixel array 110 includes sub-pixels arranged in the Tetra-Bayer pattern, the unit pixel group UPG may include eight green sub-pixels, four red sub-pixels, and four blue sub-pixels (refer to FIG. 3). For example, when the pixel array 110 includes sub-pixels arranged in the NONA pattern, the unit pixel group UPG may include 18 green sub-pixels, 9 red sub-pixels, and 9 blue sub-pixels (refer to FIG. 11A).

In some embodiments, the pixel PX may include a plurality of sub-pixels. Each of the plurality of sub-pixels may have a split photodiode structure. That is, each of the plurality of sub-pixels may include a large photodiode and a small photodiode. Compared to the small photodiode, the large photodiode may have a wider light receiving surface area. The detailed structure of the pixel PX will be described in detail with reference to the following drawings.

The row driver 120 may generate the control signals CTRL_R for controlling the plurality of pixels PX included in the pixel array 110. For example, the control signals CTRL_R may include a signal for selecting a pixel, a signal for resetting a floating diffusion node, a signal for transferring charges to the floating diffusion node of the selected pixel, etc. The row driver 120 may provide the generated control signals CTRL_R to the plurality of pixels PX.

The ramp signal generator 130 may generate a ramp signal. For example, the ramp signal generator 130 may operate in response to control signals such as a ramp enable signal and a mode signal. When the ramp enable signal is activated, the ramp signal generator 130 may generate a ramp signal based on given values (e.g., a start level, an end level, and a slope). For example, the ramp signal may be a signal which increases or decreases along the given slope during a specific time. The ramp signal may be provided to the ADC circuit 140.

The ADC circuit 140 may convert an analog signal (i.e., a pixel signal) output from the pixel array 110 into a digital signal. The ADC circuit 140 may receive analog signals (i.e., pixel signals) from a plurality of pixels of the pixel array 110 through the column lines CL and may receive the ramp signal from the ramp signal generator 130. The ADC circuit 140 may operate based on a correlated double sampling (CDS) technique for obtaining a reset signal and a data signal from the received analog signal (i.e., the received pixel signal) and extracting a difference between the reset signal and the data signal as an effective signal component. For example, the ADC circuit 140 may include a plurality of ADCs, and each ADC may include a comparator and a counter.

The output circuit 150 may receive digital signals from the ADC circuit 140. The output circuit 150 may combine the received digital signals and may output final image data IMG.

According to some embodiments of the present disclosure, the image sensor device 100 may include the pixel array 110 implemented in the tetra-cell structure through sub-pixels of the split photodiode structure (i.e., in a structure including sub-pixels arranged in the Tetra-Bayer pattern). The image sensor device 100 may improve the dynamic range by using a sensitivity difference of the large photodiode and the small photodiode. Also, the image sensor device 100 may perform a binning readout operation in which a pixel signal corresponding to a sum of charges generated by the large photodiodes included in one pixel PX is generated. Accordingly, the pixel PX may receive a sufficient amount of light even in the low-luminance environment. Accordingly, according to the present disclosure, as the binning readout operation is performed, the sensitivity of the image sensor device 100 may increase at the low luminance without the increase in the pixel size.

FIG. 3 is a circuit diagram illustrating an example of a unit pixel group of FIG. 2. Referring to FIG. 3, the unit pixel group UPG may include a plurality of pixels PX. In response to the control signals CTRL_R received from the row driver 120, each pixel PX may convert the light received from the outside into an electrical signal and may output a pixel signal PIX corresponding to the converted electrical signal through the column line CL connected thereto.

Meanwhile, each pixel PX may include four sub-pixels SPX. Accordingly, the unit pixel group UPG may include 16 sub-pixels SPX. In some embodiments, the sub-pixels SPX included in the same pixel PX may correspond to a color filter of the same color.

In other words, in some embodiments, sub-pixels included in the unit pixel group UPG may be disposed in the shape of the Tetra-Bayer pattern. That is, the unit pixel group UPG may include a pixel PX including red sub-pixels “R” converting a light of a red spectrum zone into an electrical signal, a pixel PX including blue sub-pixels “B” converting a light of a blue spectrum zone into an electrical signal, a pixel PX including green sub-pixels “Gr” converting a light of a green spectrum zone into an electrical signal, and a pixel PX including green sub-pixels “Gb” converting a light of a green spectrum zone into an electrical signal.

As illustrated in FIG. 3, the pixel PX may include first to fourth sub-pixels SPX1 to SPX4, a small reset gate SRG, a connect switch CSW, a source follower SF, and a select gate SG. The first sub-pixel SPX1 may include a first large sub-pixel LSPX1 and a first small sub-pixel SSPX1. The second sub-pixel SPX2 may include a second large sub-pixel LSPX2 and a second small sub-pixel SSPX2. The third sub-pixel SPX3 may include a third large sub-pixel LSPX3 and a third small sub-pixel SSPX3. The fourth sub-pixel SPX4 may include a fourth large sub-pixel LSPX4 and a fourth small sub-pixel SSPX4. References to “small” components (except for the small photodiode) refer to components that are electrically connected to or otherwise associated with the small photodiode and do not necessarily indicate that said component is physically smaller than other types of components, such as large components. References to “large” components (except for the large photodiode) refer to components that are electrically connected to or otherwise associated with the large photodiode and do not necessarily indicate that said component is physically larger than other types of components, such as small components.

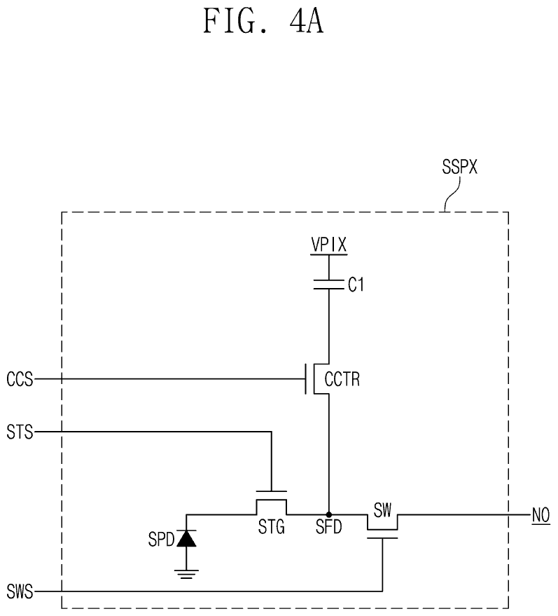

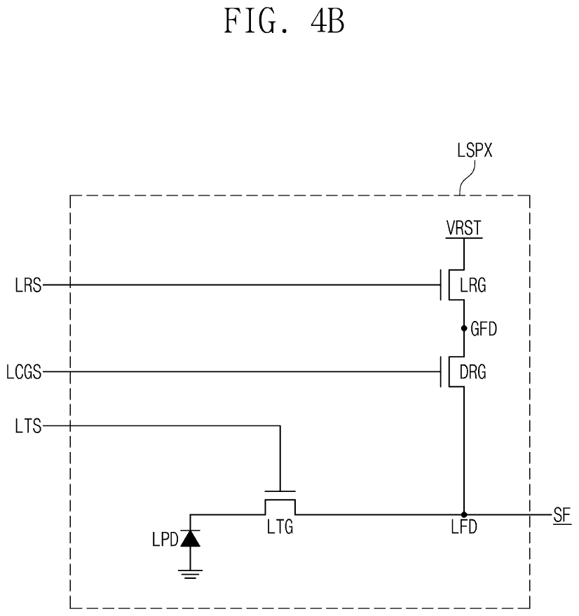

The first to fourth small sub-pixels SSPX1 to SSPX4 may be connected to a 0-th node N0. Each of the first to fourth small sub-pixels SSPX1 to SSPX4 may include a small photodiode SPD (refer to FIG. 4A). Each of the first to fourth small sub-pixels SSPX1 to SSPX4 may output the pixel signal PIX corresponding to charges generated by the small photodiode SPD (refer to FIG. 4A) through the column line CL.

The first to fourth large sub-pixels LSPX1 to LSPX4 may be connected to a large floating diffusion node LFD. Each of the first to fourth large sub-pixels LSPX1 to LSPX4 may include a large photodiode LPD (refer to FIG. 4B). Each of the first to fourth large sub-pixels LSPX1 to LSPX4 may output the pixel signal PIX corresponding to charges generated by the large photodiode LPD (refer to FIG. 4B) through the column line CL.

Meanwhile, compared to the small photodiode SPD (refer to FIG. 4A), the large photodiode LPD (refer to FIG. 4B) has the wide light receiving area. Accordingly, in the same luminance environment, the large photodiode LPD (refer to FIG. 4B) may receive a large amount of light compared to the small photodiode SPD (refer to FIG. 4A). Accordingly, the large photodiode LPD (refer to FIG. 4B) may generate effective image information in the low-luminance environment, and the small photodiode SPD (refer to FIG. 4A) may generate effective image information in the high-luminance environment. Meanwhile, in the same luminance environment, compared to the small photodiode SPD (refer to FIG. 4A), the large photodiode LPD (refer to FIG. 4B) may be quickly saturated. For example, as the size of the large photodiode LPD (refer to FIG. 4B) increases, the sensitivity of the image sensor device 100 may increase. Meanwhile, the HDR of the image sensor device 100 may be implemented based on a sensitivity difference of the large photodiode LPD (refer to FIG. 4B) and the small photodiode SPD (refer to FIG. 4A).

In some embodiments, the large photodiodes LPD (refer to FIG. 4B) included in one pixel PX may share the large floating diffusion node LFD.

The small reset gate SRG may be connected between a reset power VRST and the 0-th node N0. The small reset gate SRG may reset a small floating diffusion node SFD (refer to FIG. 4A) of the first to fourth small sub-pixels SSPX1 to SSPX4 with the reset power VRST in response to a small reset signal SRS.

The connect switch CSW may be connected between the 0-th node N0 and the large floating diffusion node LFD. The connect switch CSW may connect the 0-th node N0 and the large floating diffusion node LFD in response to a connection switch signal CSS.

The source follower SF may be connected between a pixel power VPIX and the large floating diffusion node LFD. The source follower SF may operate in response to a level (or voltage) of the large floating diffusion node LFD. The select gate SG may be connected between the source follower SF and the column line CL. The select gate SG may operate in response to a selection signal SEL.

In some embodiments, the control signals CTRL_R of FIG. 2 may include the small reset signal SRS, the connection switch signal CSS, and the selection signal SEL.

The image sensor device 100 may perform the readout operation on the pixel PX. In some embodiments, the readout operation may include the full-mode readout operation and the binning mode readout operation. The image sensor device 100 may perform the binning mode readout operation on the pixel PX by outputting the pixel signal PIX corresponding to a sum of charges generated by the large photodiodes LPD (refer to FIG. 4B) of the first to fourth large sub-pixels LSPX1 to LSPX4. That is, the binning mode readout operation may be performed based on a plurality of large photodiodes LPD (refer to FIG. 4B) included in the pixel PX. Accordingly, in the case of performing the binning mode readout operation, the light receiving area may increase compared to the case of performing the readout operation (e.g., a normal readout operation) based on one large photodiode LPD (refer to FIG. 4B). This may mean that the sensitivity of the image sensor device 100 increases and the HDR of the image sensor device 100 is easily implemented. In other words, when the image sensor device 100 performs the binning mode readout operation, the performance of the image sensor device 100 may be improved without increasing the size of the large photodiode LPD (refer to FIG. 4B). That is, in the case where the image sensor device 100 performs the binning mode readout operation, the size of the pixel PX may be reduced without the reduction of performance. Accordingly, it may be possible to easily increase the number of pixels PX of the image sensor device 100 and to increase the resolution of the image data IMG while implementing the HDR.

FIG. 4A is a circuit diagram for describing a small sub-pixel of FIG. 3, and FIG. 4B is a circuit diagram for describing a large sub-pixel of FIG. 3. FIGS. 4A and 4B will be described with reference to FIGS. 1 to 3. In some embodiments, the first to fourth small sub-pixels SSPX1 to SSPX4 of FIG. 3 may have the same structure as a small sub-pixel SSPX of FIG. 4A. In some embodiments, the first to fourth large sub-pixels LSPX1 to LSPX4 of FIG. 3 may have the same structure of a large sub-pixel LSPX of FIG. 4B. Referring to FIG. 4A, the small sub-pixel SSPX may include the small photodiode SPD, a small transfer gate STG, a capacitor control transistor CCTR, a first capacitor C1, and a switch SW.

The small photodiode SPD may be connected between a ground power and the small transfer gate STG. The small photodiode SPD may generate charges based on a light received from the outside. For example, the small photodiode SPD may generate effective image information in the high-luminance environment.

The small transfer gate STG may be connected between the small photodiode SPD and the small floating diffusion node SFD. The small transfer gate STG may transfer the charges generated by the small photodiode SPD to the small floating diffusion node SFD in response to a small transfer signal STS.

The capacitor control transistor CCTR may be connected between the small floating diffusion node SFD and the first capacitor C1. The capacitor control transistor CCTR may operate in response to a capacitor control signal CCS and may adjust a conversion gain of the small sub-pixel SSPX. The conversion gain when the capacitor control transistor CCTR is turned off may be higher than the conversion gain when the capacitor control transistor CCTR is turned on. When the capacitor control transistor CCTR is in a turn-off state, the small sub-pixel SSPX may be referred to as “operating in a high conversion gain mode”. When the capacitor control transistor CCTR is in a turn-on state, the small sub-pixel SSPX may be referred to as “operating in a low conversion gain mode”. Meanwhile, the high conversion gain mode may be advantageous in the low-luminance environment, and the low conversion gain mode may be advantageous in the high-luminance environment.

The first capacitor C1 may be connected between the capacitor control transistor CCTR and the pixel power VPIX. However, the present disclosure is not limited thereto. For example, the first capacitor C1 may be connected to a power different from the pixel power VPIX. For example, charges overflowed from the small photodiode SPD may be stored in the first capacitor C1.

The switch SW may be connected between the small floating diffusion node SFD and the 0-th node N0 and may operate in response to a switching signal SWS. The switch SW may transfer charges stored at the small floating diffusion node SFD to the large floating diffusion node LFD (refer to FIG. 3) in response to the switching signal SWS.

As described above, the first to fourth small sub-pixels SSPX1 to SSPX4 of the pixel PX may have the same structure as the small sub-pixel SSPX and may be configured to share the small reset gate SRG.

In some embodiments, the control signals CTRL_R of FIG. 2 may include the capacitor control signal CCS, the small transfer signal STS, and the switching signal SWS.

Referring to FIG. 4B, the large sub-pixel LSPX may include the large photodiode LPD, a large transfer gate LTG, a gain control gate DRG, and a large reset gate LRG.

The large photodiode LPD may be connected between the ground power and the large transfer gate LTG. The large photodiode LPD may generate charges based on a light received from the outside. As described above, the large photodiode LPD has the wide light receiving area compared to the small photodiode SPD. For example, the large photodiode LPD may generate effective image information in the low-luminance environment.

The large transfer gate LTG may be connected between the large photodiode LPD and the large floating diffusion node LFD. The large transfer gate LTG may transfer the charges generated by the large photodiode LPD to the large floating diffusion node LFD in response to a large transfer signal LTS. Meanwhile, the large floating diffusion node LFD of FIG. 4B may be the large floating diffusion node LFD of FIG. 3. The large floating diffusion node LFD may be connected to the source follower SF. That is, the first to fourth large sub-pixels LSPX1 to LSPX4 (refer to FIG. 3) may be configured to share one large floating diffusion node LFD.

The gain control gate DRG may be connected between the large floating diffusion node LFD and a gain control floating diffusion node GFD. The gain control gate DRG may operate in response to a large gain control signal LCGS and may adjust a conversion gain of the large sub-pixel LSPX. When the gain control gate DRG is in a turn-on state, the large floating diffusion node LFD may be connected to the gain control floating diffusion node GFD. Accordingly, the conversion gain when the gain control gate DRG is in a turn-off state may be higher than the conversion gain when the gain control gate DRG is in a turn-on state. When the gain control gate DRG is in a turn-off state, the large sub-pixel LSPX may be referred to as “operating in the high conversion gain mode”. When the gain control gate DRG is in a turn-on state, the large sub-pixel LSPX may be referred to as “operating in the low conversion gain mode”.

The large reset gate LRG may be connected between the reset voltage VRST and the gain control floating diffusion node GFD. The large reset gate L RG may reset the large floating diffusion node LFD with the reset voltage VRST in response to a large reset signal LRS.

In some embodiments, the control signals CTRL_R of FIG. 2 may include the large transfer signal LTS, the large gain control signal LCGS, and the large reset signal LRS.

In some embodiments, the large photodiode LPD and the small photodiode SPD may selectively operate depending on ambient luminance of an object. For example, the large photodiode LPD may operate to generate a pixel signal in the low-luminance environment, and the small photodiode SPD may operate to generate a pixel signal in the high-luminance environment. As the images obtained from the large photodiode LPD and the small photodiode SPD are merged, the dynamic range of the image sensor device 100 may be improved (i.e., the HDR may be implemented).

In some embodiments, in the binning mode readout operation described with reference to FIG. 3, in the high conversion gain mode, the large transfer gates LTG of the first to fourth large sub-pixels LSPX1 to LSPX4 may be simultaneously turned on. Because the first to fourth large sub-pixels LSPX1 to LSPX4 share the large floating diffusion node LFD, a sum of charges generated by the first to fourth large sub-pixels LSPX1 to LSPX4 may be stored at the large floating diffusion node LFD. Accordingly, the pixel PX may output the pixel signal PIX corresponding to the sum of charges generated by the large photodiodes LPD through the binning mode readout operation. In this case, the pixel signal PIX may correspond to a pixel signal generated by a photodiode whose light receiving area is wider than that of one large photodiode LPD. Accordingly, the image sensor device 100 may implement a clear image even in an ultra-low-luminance situation.

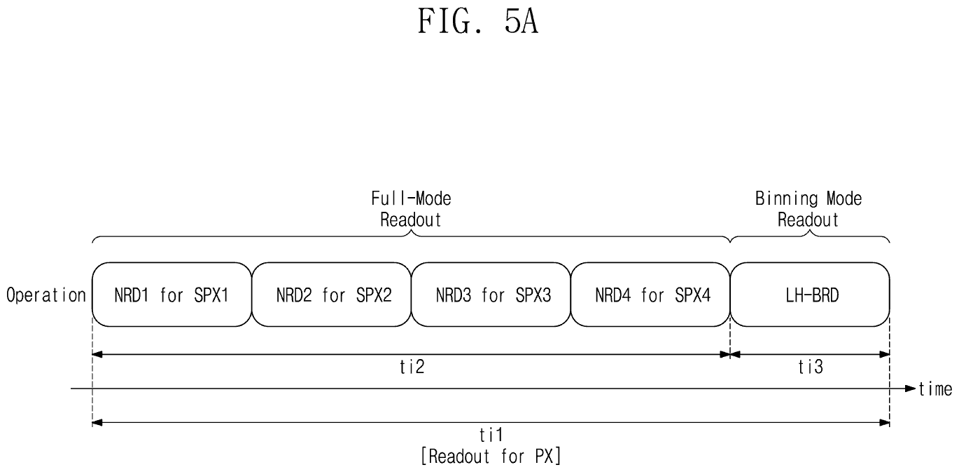

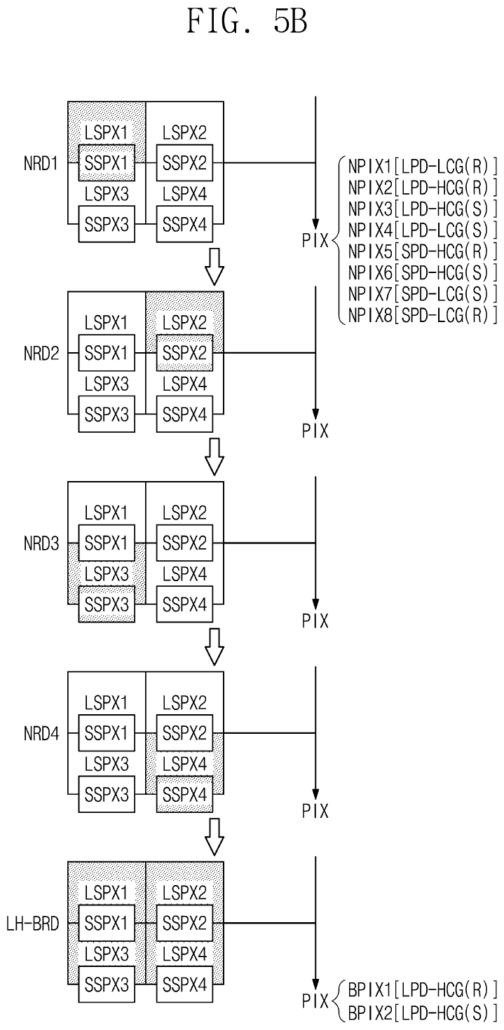

FIGS. 5A and 5B are diagrams for describing an example of a readout operation of an image sensor device of FIG. 2. FIGS. 5A and 5B will be described with reference to FIGS. 1 to 4B. Referring to FIG. 5A, during a first time interval ti1, the image sensor device 100 may perform the readout operation on the pixel PX. The readout operation may include the full-mode readout operation and the binning mode readout operation. For example, the full-mode readout operation may be performed during a second time interval ti2 included in the first time interval ti1, and the binning mode readout operation may be included in the first time interval ti1 and may be performed in a third time interval ti3 after the second time interval ti2.

In some embodiments, the full-mode readout operation may include first to fourth normal readout operations NRD1 to NRD4. The first normal readout operation NRD1 may be performed on the first sub-pixel SPX1, the second normal readout operation NRD2 may be performed on the second sub-pixel SPX2, the third normal readout operation NRD 3 may be performed on the third sub-pixel SPX3, and the fourth normal readout operation NRD4 may be performed on the fourth sub-pixel SPX4. That is, while the full-mode readout operation is performed, the image sensor device 100 may sequentially perform the first to fourth normal readout operations NRD1 to NRD4.

In some embodiments, each of the first to fourth normal readout operations NRD1 to NRD4 may include LPD-LCG readout, LPD-HCG readout, SPD-HCG readout, and SPD-LCG readout. The LPD-LCG readout indicates an operation of reading out the pixel signal from the large photodiode LPD of the sub-pixel SPX targeted for the normal readout operation in the low conversion gain mode; the LPD-HCG readout indicates an operation of reading out the pixel signal from the large photodiode LPD of the sub-pixel SPX targeted for the normal readout operation in the high conversion gain mode; the SPD-HCG readout indicates an operation of reading out the pixel signal from the small photodiode SPD of the sub-pixel SPX targeted for the normal readout operation in the high conversion gain mode; and the SPD-LCG readout indicates an operation of reading out the pixel signal from the small photodiode SPD of the sub-pixel SPX targeted for the normal readout operation in the low conversion gain mode.

In some embodiments, the binning mode readout operation may include an LPD-HCG binning readout operation LH-BRD. The LPD-HCG binning readout operation LH-BRD may indicate an operation of outputting the pixel signal by allowing the first to fourth large sub-pixels LSPX1 to LSPX4 included in the pixel PX to operate at the same time in the high conversion gain mode.

Referring to FIG. 5B, the image sensor device 100 may perform the first normal readout operation NRD1 on the first sub-pixel SPX1. The first normal readout operation NRD1 may indicate an operation of outputting the pixel signals PIX from the first large sub-pixel LSPX1 and the first small sub-pixel SSPX1 included in the first sub-pixel SPX1.

While the first normal readout operation NRD1 is performed, the first sub-pixel SPX1 may sequentially output first to eighth normal pixel signals NPIX1 to NPIX8 as the pixel signal PIX. In this case, for example, the first normal pixel signal NPIX1 may indicate the reset signal by the LPD-LCG readout; the second normal pixel signal NPIX2 may indicate the reset signal by the LPD-HCG readout; the third normal pixel signal NPIX3 may indicate the data signal by the LPD-HCG readout; the fourth normal pixel signal NPIX4 may indicate the data signal by the LPD-LCG readout; the fifth normal pixel signal NPIX5 may indicate the reset signal by the SPD-HCG readout; the sixth normal pixel signal NPIX6 may indicate the data signal by the SPD-HCG readout; the seventh normal pixel signal NPIX7 may indicate the data signal by the SPD-LCG readout; and, the eighth normal pixel signal NPIX8 may indicate the reset signal by the SPD-LCG readout.

That is, the pixel signals PIX output from the pixel PX during the first normal readout operation NRD1 may include the first to eighth normal pixel signals NPIX1 to NPIX8.

Meanwhile, as in the first normal readout operation NRD1, the image sensor device 100 may perform the second to fourth normal readout operations NRD2 to NRD4 on the second to fourth sub-pixels SPX2 to SPX4. That is, the image sensor device 100 may perform the second normal readout operation NRD2 such that the pixel signal PIX is output from the second large sub-pixel LSPX2 and the second small sub-pixel SSPX2, may perform the third normal readout operation NRD3 such that the pixel signal PIX is output from the third large sub-pixel LSPX3 and the third small sub-pixel SSPX3, and may perform the fourth normal readout operation NRD4 such that the pixel signal PIX is output from the fourth large sub-pixel LSPX4 and the fourth small sub-pixel SSPX4.

An example in which the LPD-HCG readout operation and the LPD-LCG readout operation are performed based on the RRSS manner is illustrated in FIG. 5B, but the present disclosure is not limited thereto. Accordingly, the image sensor device 100 may perform a normal readout operation (e.g., NRD1) on a large sub-pixel (e.g., LPSX1) in various methods.

Meanwhile, after the first to fourth normal readout operations NRD1 to NRD4 are performed, the image sensor device 100 may perform the LPD-HCG binning readout operation LH-BRD on the first to fourth large sub-pixels LSPX1 to LSPX4. While the LPD-HCG binning readout operation LH-BRD is performed, the pixel PX may sequentially output a first binning pixel signal BPIX1 and a second binning pixel signal BPIX2 as the pixel signal PIX.

In some embodiments, while the LPD-HCG binning readout operation LH-BRD is performed, the first to fourth large sub-pixels LSPX1 to LSPX4 may simultaneously operate in response to the control signals CTRL_R (refer to FIG. 2).

The first binning pixel signal BPIXI indicates a reset signal “R” generated based on the first to fourth large sub-pixels LSPX1 to LSPX4 in the high conversion gain mode, and the second binning pixel signal BPIX2 indicates a data signal “S” corresponding to a sum of charges generated by the large photodiodes LPD included in the pixel PX.

In some embodiments, the image data IMG (refer to FIG. 2) generated based on the first binning pixel signal BPIX1 and the second binning pixel signal BPIX2 may correspond to image data in the low-luminance environment.

In some embodiments, image data obtained from normal pixel signals generated through the first to fourth normal readout operations NRD1 to NRD4 and binning pixel signals generated through the LPD-HCG binning readout operation LH-BRD may be merged. The merged data may be HDR image data. Accordingly, the HDR of the image sensor device 100 may be implemented.

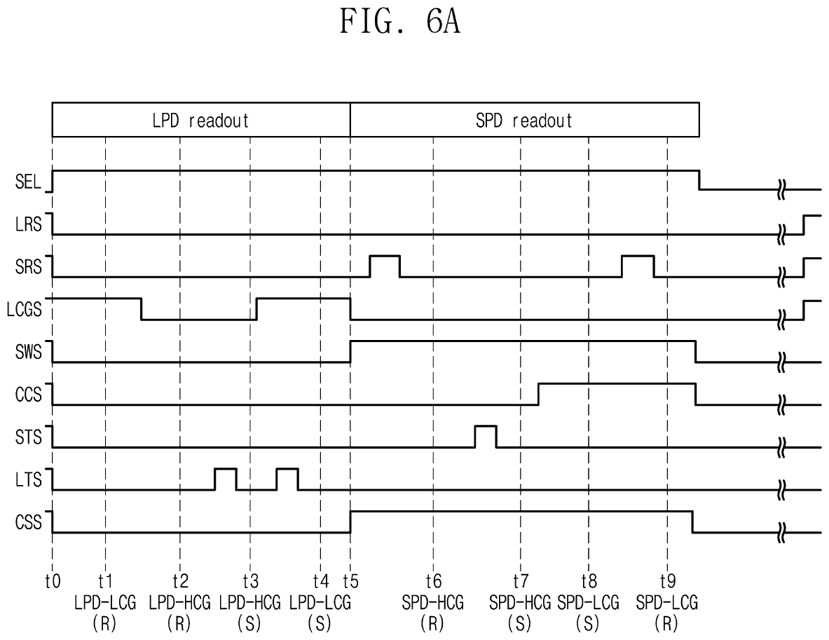

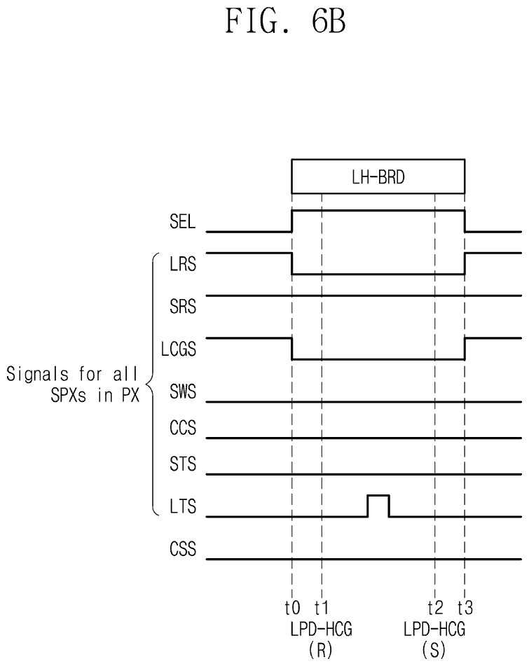

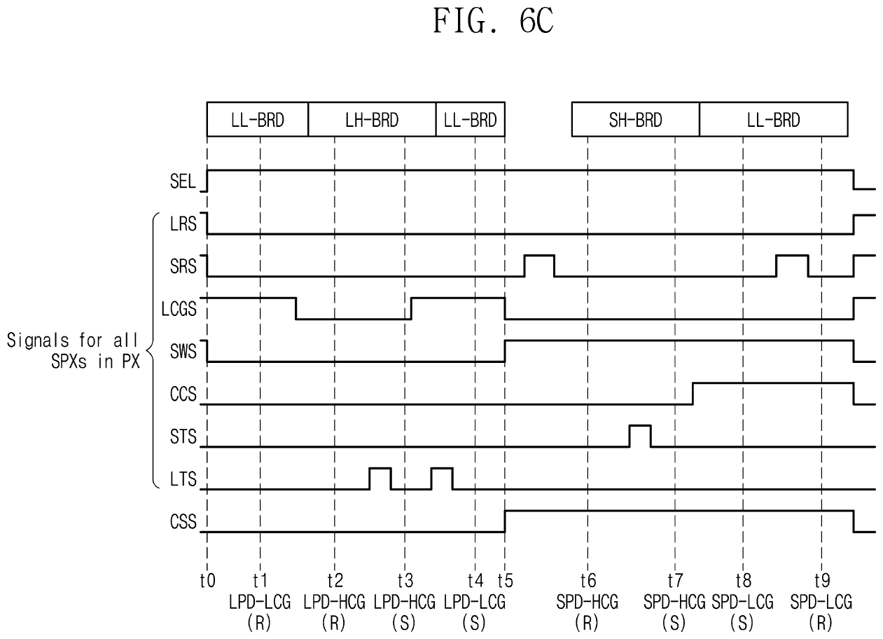

FIGS. 6A to 6C are timing diagrams for describing a normal readout operation and a binning mode readout operation of FIG. 5A. FIG. 6A is a timing diagram for describing the first normal readout operation NRD1. Accordingly, the large reset signal LRS, the large gain control signal LCGS, the switching signal SWS, the capacitor control signal CCS, the small transfer signal STS, and the large transfer signal LTS of FIG. 6A indicate signals to be applied to the first sub-pixel SPX1. For convenience of description and for brevity of drawing, only the timing diagram for the first normal readout operation NRD1 is illustrated, but the second to fourth normal readout operations NRD2 to NRD4 may also be performed in the same method as illustrated in FIG. 6A.

In some embodiments, while the first normal readout operation NRD1 is performed, the large reset signal LRS, the large gain control signal LCGS, the switching signal SWS, the capacitor control signal CCS, the small transfer signal STS, and the large transfer signal LTS which are applied to the second to fourth sub-pixels SPX2 to SPX4 may be in a logic low state.

Referring to FIG. 6A, before the first normal readout operation NRD1 is performed (i.e., before a 0-th point in time t0), there may be a state where the reset operation on the first large sub-pixel LSPX1 and the first small sub-pixel SSPX1 is performed. Accordingly, before the first normal readout operation NRD1 is performed, the large floating diffusion node LFD of the first large sub-pixel LSPX1 and the small floating diffusion node SFD of the first small sub-pixel SSPX1 may be in a state of being reset with the reset power VRST.

As illustrated in FIG. 6A, at the 0-th point in time t0, the first normal readout operation NRD1 may be initiated. While the first normal readout operation NRD1 is performed, the image sensor device 100 may read out the pixel signals PIX corresponding to the large photodiode LPD and may read out the pixel signals PIX corresponding to the small photodiode SPD.

At the 0-th point in time t0, the selection signal SEL may transition to a logic high level. In this case, the select gate SG may be turned on, and the pixel PX may be connected to the column line CL. Meanwhile, the switching signal SWS may transition to a logic low level. The switch SW of the first small sub-pixel SSPX1 may be turned off in response to the switching signal SWS. Meanwhile, the connection switch signal CSS may be in a logic low state, and the connect switch CSW may be in a turn-off state. In this case, the first large sub-pixel LSPX1 may be connected to the column line CL, and the first small sub-pixel SSPX1 may not be connected to the column line CL. Accordingly, the execution of the readout operation (i.e., the LPD readout operation) may be initiated based on the large photodiode LPD of the first large sub-pixel LSPX1.

At a first point in time t1, the large gain control signal LCGS may be at the logic high level. In this case, the gain control gate DRG may be in a turn-on state. That is, the first large sub-pixel LSPX1 may operate in the low conversion gain mode. The first large sub-pixel LSPX1 may output a reset signal LPD-LCG(R) (i.e., the first normal pixel signal NPIX1 of FIG. 5B) in the low conversion gain mode.

Between the first point in time t1 and a second point in time t2, the large gain control signal LCGS may transition to the logic low level. In this case, the gain control gate DRG may be turned off, and the first large sub-pixel LSPX1 may operate in the high conversion gain mode. At the second point in time t2, the first large sub-pixel LSPX1 may output a reset signal LPD-HCG(R) (i.e., the second normal pixel signal NPIX2 of FIG. 5B) in the high conversion gain mode.

Between the second point in time t2 and a third point in time t3, the large transfer gate LTG may be turned on based on the large transfer signal LTS. In this case, in the high conversion gain mode, charges generated by the large photodiode LPD of the first large sub-pixel LSPX1 may be transferred to the large floating diffusion node LFD. At the third point in time t3, the first large sub-pixel LSPX1 may output a data signal LPD-HCG(S) (i.e., the third normal pixel signal NPIX3 of FIG. 5B) in the high conversion gain mode.

Between the third point in time t3 and a fourth point in time t4, the large gain control signal LCGS may again transition to the logic high level, and the gain control gate DR G may be turned on. Also, the large transfer gate LTG may be turned on based on the large transfer signal LTS. In this case, in the low conversion gain mode, charges generated by the large photodiode LPD of the first large sub-pixel LSPX1 may be transferred to the large floating diffusion node LFD. At the fourth point in time t4, the first large sub-pixel LSPX1 may output a data signal LPD-LCG(S) (i.e., the fourth normal pixel signal NPIX4 of FIG. 5B) in the low conversion gain mode.

At a fifth point in time t5, the large gain control signal LCGS may transition to the logic low level, and the switching signal SWS and the connection switch signal CSS may transition to the logic high level. In this case, the connect switch CSW and the switch SW of the first small sub-pixel SSPX1 may be turned on, and the column line CL and the first small sub-pixel SSPX1 may be connected. Accordingly, the readout operation (i.e., the SPD readout operation) may be initiated based on the small photodiode SPD of the first small sub-pixel SSPX1.

Between the fifth point in time t5 and a sixth point in time t6, the small reset signal SRS may transition to the logic high level. Accordingly, the small floating diffusion node SFD of the first small sub-pixel SSPX1 and the large floating diffusion node LFD of the pixel PX may be reset with the reset power VRST.

At the sixth point in time t6, the capacitor control signal CCS may be at the logic low level. In this case, the capacitor control transistor CCTR may be in a turn-off state, and the first small sub-pixel SSPX1 may operate in the high conversion gain mode. The first small sub-pixel SSPX1 may output a reset signal SPD-HCG(R) (i.e., the fifth normal pixel signal NPIX5 of FIG. 5B) in the high conversion gain mode.

Between the sixth point in time t6 and a seventh point in time t7, the small transfer gate STG may be turned on based on the small transfer signal STS. In this case, in the high conversion gain mode, charges generated by the small photodiode SPD of the first small sub-pixel SSPX1 may be transferred to the small floating diffusion node SFD of the first small sub-pixel SSPX1. At the seventh point in time t7, the first small sub-pixel SSPX1 may output a data signal SPD-HCG(S) (i.e., the sixth normal pixel signal NPIX6 of FIG. 5B) in the high conversion gain mode.

Between the seventh point in time t7 and an eighth point in time t8, the capacitor control transistor CCTR may be turned on in response to the capacitor control signal CCS. In this case, the small floating diffusion node SFD of the first small sub-pixel SSPX1 may be connected to the first capacitor C1. Accordingly, the first small sub-pixel SSPX1 may operate in the low conversion gain mode. At the eighth point in time t8, the first small sub-pixel SSPX1 may output a data signal SPD-LCG(S) (i.e., the seventh normal pixel signal NPIX7 of FIG. 5B) in the low conversion gain mode.

Between the eighth point in time t8 and a ninth point in time t9, the small reset signal SRS may transition to the logic high level, and the small floating diffusion node SFD of the first small sub-pixel SSPX1 may be reset. At the ninth point in time t9, the first small sub-pixel SSPX1 may output a reset signal SPD-LCG(R) (i.e., the eighth normal pixel signal NPIX8 of FIG. 5B) in the low conversion gain mode.

After the ninth point in time t9, the selection signal SEL, the switching signal SWS, the capacitor control signal CCS, and the connection switch signal CSS may transition to the logic low level. Accordingly, the execution of the first normal readout operation NRD1 on the first sub-pixel SPX1 may be completed. After the execution of the first normal readout operation NRD1 is completed, as in the first normal readout operation NRD1, the image sensor device 100 may perform the second to fourth normal readout operations NRD2 to NRD4 on the second to fourth sub-pixels SPX2 to SPX4.

FIG. 6B is a timing diagram for describing the LPD-HCG binning readout operation LH-BRD (refer to FIGS. 5A and 5B). The large reset signal LRS, the large gain control signal LCGS, the switching signal SWS, the capacitor control signal CCS, the small transfer signal STS, and the large transfer signal LTS of FIG. 6B may indicate levels of signals to be applied to all the sub-pixels SPX1 to SPX4. That is, the LPD-HCG binning readout operation LH-BRD may be performed in a state where the first to fourth large sub-pixels LSPX1 to LSPX4 are treated as one pixel. That is, while the LPD-HCG binning readout operation LH-BRD is performed, the first to fourth large sub-pixels LSPX1 to LSPX4 may simultaneously operate.

In some embodiments, before the LPD-HCG binning readout operation LH-BRD is performed (e.g., before a 0-th point in time t0), the large floating diffusion node LFD of the pixel PX may be reset. For example, the large floating diffusion node LFD may be reset with the reset power VRST by the large reset gates LRG of the first to fourth large sub-pixels LSPX1 to LSPX4.

Meanwhile, as illustrated in FIG. 6B, while the LPD-HCG binning readout operation LH-BRD is performed, the connection switch signal CSS may be in a logic low state. Accordingly, the LPD-HCG binning readout operation LH-BRD may be performed based on the first to fourth large sub-pixels LSPX1 to LSPX4 of the pixel PX.

Returning to FIG. 6B, at the 0-th point in time to, the select gate SG of the pixel PX may be turned on in response to the selection signal SEL. In this case, the execution of the LPD-HCG binning readout operation LH-BRD on the pixel PX may be initiated. Meanwhile, the large reset signals LRS and the large gain control signals LCGS of the first to fourth large sub-pixels LSPX1 to LSPX4 may transition from the logic high level to the logic low level. Also, after the 0-th point in time t0, the gain control gates DRG of the first to fourth large sub-pixels LSPX1 to LSPX4 may be in a turn-off state, and the pixel PX may operate in the high conversion gain mode.

At a first point in time t1, the pixel PX may output the reset signal LPD-HCG(R) (i.e., the first binning pixel signal BPIX1 of FIG. 5B) based on the large photodiodes LPD.

Between the first point in time t1 and a second point in time t2, the large transfer gates LTG of the first to fourth large sub-pixels LSPX1 to LSPX4 may be turned on in response to the large transfer signals LTS. In this case, charges generated by the large photodiodes LPD of the first to fourth large sub-pixels LSPX1 to LSPX4 may be transferred to the large floating diffusion node LFD. As described above, the large photodiodes LDP of the pixel PX may share the large floating diffusion node LFD. Accordingly, the amount of charges stored at the large floating diffusion node LFD may correspond to a sum of charges generated by the large photodiodes LPD.

In some embodiments, during a time period from the first point in time t1 to the second point in time t2, the large transfer gates LTG of the first to fourth large sub-pixels LSPX1 to LSPX4 may be simultaneously turned on.

At the second point in time t2, the pixel PX may output the data signal LPD-HCG(S) (i.e., the second binning pixel signal BPIX2 of FIG. 5B) based on the large photodiodes LPD in the high conversion gain mode. In this case, the data signal LPD-HCG(S) may correspond to a sum of charges generated by the large photodiodes LPD of the pixel PX.

At a third point in time t3, the large reset signal LRS and the large gain control signal LCGS may transition to the logic high level. In this case, the large floating diffusion node LFD may be reset by the first to fourth large sub-pixels LSPX1 to LSPX4, and the execution of the LPD-HCG binning readout operation LH-BRD may be terminated.

As described above, the image sensor device 100 may implement the HDR based on the sensitivity difference of the large photodiode LPD and the small photodiode SPD. Meanwhile, unlike the description given with reference to FIGS. 5A to 6B, the readout operation on the pixel PX may not include the LPD-HCG binning readout operation LH-BRD. In this case, the image clarity in the low-luminance environment may be determined based on the light receiving area. In other words, the image clarity in the low-luminance environment may be determined based on the size of the large photodiode LPD. Accordingly, it may be difficult to reduce the size of the large photodiode LPD to implement a clear image even in an ultra-low-luminance situation and to implement a wide HDR. Accordingly, like the image sensor device 100 for vehicle, when a wide dynamic range is required, it may be difficult to increase the number of pixels PX to be included in the image sensor device 100.

In contrast, as described above, according to some embodiments of the present disclosure, the readout operation on the pixel PX may include the LPD-HCG binning readout operation LH-BRD. The LPD-HCG binning readout operation LH-BRD may be performed as the first to fourth large sub-pixels LSPX1 to LSPX4 simultaneously operate. In other words, the plurality of large photodiodes LPD may operate like one (i.e., a single) photodiode. Accordingly, even though the size of each large photodiode LPD decreases, the large photodiodes LPD may generate charges based on the sufficient light receiving area in the low-luminance environment (e.g., based on a sum of the light receiving areas of the plurality of large photodiodes LPD). In other words, even though the size of the large photodiode LPD decreases, the dynamic range of the image sensor device 100 may not decrease. Accordingly, without the reduction of performance, it may be possible to increase the number of pixels PX included in the image sensor device 100 and to implement the high-definition image sensor device 100.

FIG. 6C is a diagram for describing another example of a binning mode readout operation. The large reset signal LRS, the large gain control signal LCGS, the switching signal SWS, the capacitor control signal CCS, the small transfer signal STS, and the large transfer signal LTS of FIG. 6C may indicate levels of signals to be applied to the all the sub-pixels SPX1 to SPX4 of the pixel PX. Referring to FIG. 6C, the binning mode readout operation may include an LPD-LCG binning readout operation LL-BRD, an SPD-HCG binning readout operation SH-BRD, and an SPD-LCG binning readout operation SL-BRD as well as the LPD-HCG binning readout operation LH-BRD. The LPD-LCG binning readout operation LL-BRD may indicate an operation of outputting the pixel signal PIX by allowing the first to fourth large sub-pixels LSPX1 to LSPX4 of the pixel PX to operate at the same time in the low conversion gain mode. The SPD-HCG binning readout operation SH-BRD may indicate an operation of outputting the pixel signal PIX by allowing the first to fourth small sub-pixels SSPX1 to SSPX4 included in the pixel PX to operate at the same time in the high conversion gain mode. The SPD-LCG binning readout operation SL-BRD may indicate an operation of outputting the pixel signal PIX by allowing the first to fourth small sub-pixels SSPX1 to SSPX4 of the pixel PX to operate at the same time in the low conversion gain mode. Operations of the timing diagram of FIG. 6C are substantially the same as the operations of the timing diagram of FIG. 6A except that the sub-pixels LSPX1 to LSPX4 and SSPX1 to SSPX4 simultaneously operate, and thus, additional description will be omitted to avoid redundancy.

As described above, FIGS. 6A to 6C are timing diagrams associated with examples of the operation of the image sensor device 100 according to some embodiments of the present disclosure. However, the present disclosure is not limited thereto. The operation timing of the image sensor device 100 may be variously changed and modified without departing from the scope and spirit of the invention.

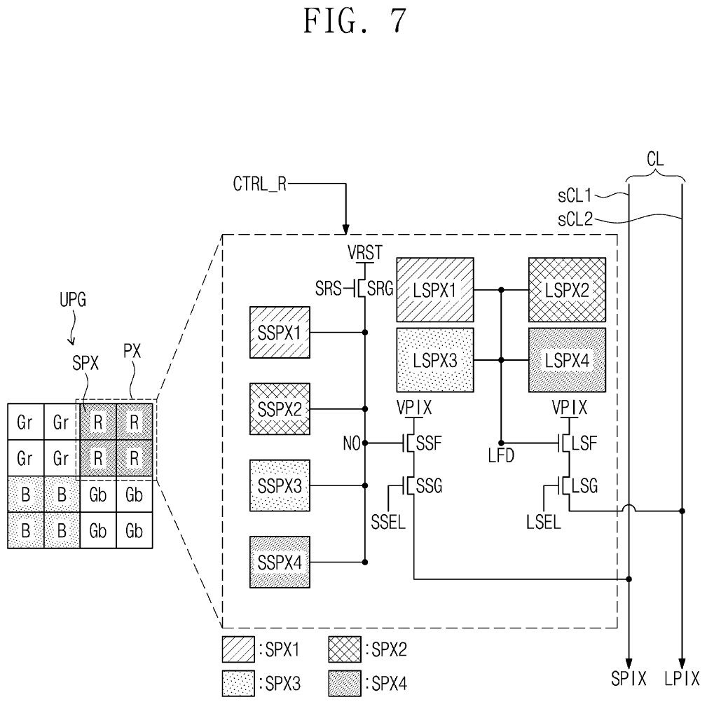

FIG. 7 is a circuit diagram illustrating another example of a unit pixel group of FIG. 2. In detail, FIG. 7 shows the pixel PX in which the first to fourth small sub-pixels SSPX1 to SSPX4 and the first to fourth large sub-pixels LSPX1 to LSPX4 do not share source followers (e.g., SSF and LSF) and select gates (e.g., SSG and LSG). Below, a difference between the pixel PX of FIG. 3 and the pixel PX of FIG. 7 will be mainly described.

Unlike the pixel PX of FIG. 3, the column line CL may include a first sub-column line sCL1 and a second sub-column line sCL2. The pixel PX may output a small pixel signal SPIX through the first sub-column line sCL1 and may output a large pixel signal LPIX through the second sub-column line sCL2.

Referring to FIG. 7, the pixel PX may include the small reset gate SR G, the first to fourth small sub-pixels SSPX1 to SSPX4, the small source follower SSF, the small select gate SSG, the first to fourth large sub-pixels LSPX1 to LSPX4, the large source follower LSF, and the large select gate LSG. The first to fourth small sub-pixels SSPX1 to SSPX4 may be connected to the small source follower SSF through the 0-th node N0. The small source follower SSF may be connected between the pixel power VPIX and the small select gate SSG. The small source follower SSF may operate in response to a level of the 0-th node N0. Meanwhile, for example, the switch SW (refer to FIG. 4A) of a small sub-pixel (e.g., SSPX1) may be turned on. In this case, the level of the 0-th node N0 may be a level of the small floating diffusion node SFD of the small sub-pixel (e.g., SSPX1). The small select gate SSG may be connected between the first sub-column line sCL1 and the small source follower SSF. The small select gate SSG may operate in response to a small selection signal SSEL.

The first to fourth large sub-pixels LSPX1 to LSPX4 may be connected to the second sub-column line sCL2 through the large floating diffusion node LFD, the large source follower LSF, and the large select gate LSG. The large select gate LSG may operate in response to a large selection signal LSEL. That is, according to the embodiment of FIG. 7, the first to fourth large sub-pixels LSPX1 to LSPX4 and the first to fourth small sub-pixels SSPX1 to SSPX4 may individually output the large pixel signal LPIX and the small pixel signal SPIX through the first sub-column line sCL1 and the second sub-column line sCL2.

In some embodiments, the pixel PX of FIG. 2 may be implemented like the pixel PX of FIG. 7. In this case, the ADC, which is included in the ADC circuit 140 (refer to FIG. 2) and is connected to the column line CL, may include a first sub-ADC (not illustrated) connected to the first sub-column line sCL1 and a second sub-ADC (not illustrated) connected to the second sub-column line sCL2.

In some embodiments, the control signals CTRL_R may include the small selection signal SSEL and the large selection signal LSEL.

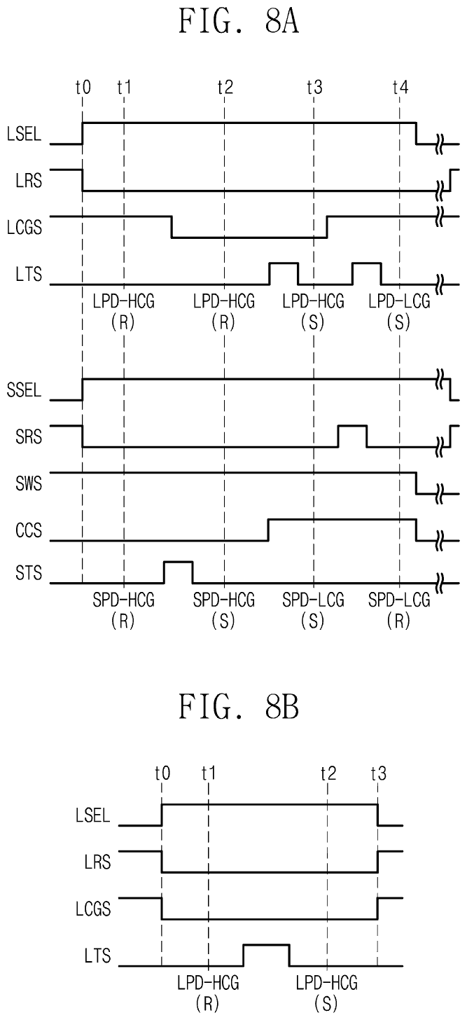

FIGS. 8A and 8B are timing diagrams for describing a readout operation on a pixel of FIG. 7. As described with reference to FIGS. 5A and 5B, the readout operation may include the first to fourth normal readout operations NRD1 to NRD4 (refer to FIG. 5A) and the LPD-HCG binning readout operation LH-BRD (refer to FIG. 5A). FIG. 8A is a timing diagram for describing the normal readout operation NRD1 (refer to FIG. 5A) on the first sub-pixel SPX1. Accordingly, the large reset signal LRS, the large gain control signal LCGS, the large transfer signal LTS, the switching signal SWS, the capacitor control signal CCS, and the small transfer signal STS of FIG. 8A indicate signals to be applied to the first sub-pixel SPX1. As in the operation method according to the timing diagram of FIG. 8A, the image sensor device 100 may perform the second to fourth normal readout operations NRD2 to NRD4 of FIG. 7 on the second to fourth sub-pixels SPX2 to SPX4.

As illustrated in FIG. 8A, before the first normal readout operation NRD1 is performed (i.e., before the 0-th point in time t0), there may be a state where the reset operation on the first large sub-pixel LSPX1 and the first small sub-pixel SSPX1 is performed. Accordingly, before the first normal readout operation NRD1 is performed, the large floating diffusion node LFD of the first large sub-pixel LSPX1 and the small floating diffusion node SFD of the first small sub-pixel SSPX1 may be in a state of being reset with the reset power VRST.

Unlike the case of FIG. 3, according to the embodiment of FIG. 7, the first small sub-pixel SSPX1 and the first large sub-pixel LSPX1 may simultaneously output pixel signals (e.g., SPIX and LPIX). In detail, while the first small sub-pixel SSPX1 outputs the small pixel signal SPIX through the first sub-column line sCL1, the first large sub-pixel LSPX1 may output the large pixel signal LPIX through the second sub-column line sCL2.

At the first point in time t1, the first large sub-pixel LSPX1 may output the reset signal LPD-LCG(R) through the second sub-column line sCL2 in the low conversion gain mode. Meanwhile the first small sub-pixel SSPX1 may output the reset signal SPD-HCG(R) through the first sub-column line sCL1 in the high conversion gain mode.

At the second point in time t2, the first large sub-pixel LSPX1 may output the reset signal LPD-HCG(R) through the second sub-column line sCL2 in the high conversion gain mode. Meanwhile, the first small sub-pixel SSPX1 may output the data signal SPD-HCG(R) through the first sub-column line sCL1 in the high conversion gain mode.

At the third point in time t3, the first large sub-pixel LSPX1 may output the data signal LPD-HCG(S) through the second sub-column line sCL2 in the high conversion gain mode. Meanwhile, the first small sub-pixel SSPX1 may output the data signal SPD-LCG(S) through the first sub-column line sCL1 in the low conversion gain mode.

At the fourth point in time t4, the first large sub-pixel LSPX1 may output the data signal LPD-LCG(S) through the second sub-column line sCL2 in the low conversion gain mode. Meanwhile, the first small sub-pixel SSPX1 may output the reset signal SPD-LCG(R) through the first sub-column line sCL1 in the low conversion gain mode.

Unlike the case of FIG. 3, in the case of the pixel PX of FIG. 7, the small pixel signal SPIX and the large pixel signal LPIX may be simultaneously output. That is, a large sub-pixel (e.g., LSPX1) and a small sub-pixel (e.g., SSPX1) may operate in parallel. Accordingly, when the pixel PX is implemented as illustrated in FIG. 7, a speed at which a normal readout operation (e.g., NRD1) is performed may be faster than that of the case of FIG. 3.

FIG. 8B is a timing diagram for describing the LPD-HCG binning readout operation LH-BRD (refer to FIGS. 5A and 5B). The large reset signal LRS, the large gain control signal LCGS, and the large transfer signal LTS of FIG. 8B may indicate levels of signals to be to be applied to all the large sub-pixels LSPX1 to LSPX4 of the pixel PX. That is, while the LCG-HCG binning readout operation (LH-BRD of FIGS. 5A and 5B) is performed, the first to fourth large sub-pixels LSPX1 to LSPX4 may simultaneously operate.

In some embodiments, while the LPD-HCG binning readout operation LH-BRD is performed, the first to fourth small sub-pixels SSPX1 to SSPX4 may not output the small pixel signal SPIX.

As illustrated in FIG. 8B, the image sensor device 100 may perform the LPD-HCG binning readout operation LH-BRD from the 0-th point in time t0 to the third point in time t3. At the first point in time t1, the pixel PX may output the reset signal LPD-HCG(R) based on the large photodiodes LPD in the high conversion gain mode. At the second point in time t2, the pixel PX may output the data signal LPD-HCG(S) based on the large photodiodes LPD in the high conversion gain mode. In this case, the data signal LPD-HCG(S) may correspond to a sum of charges generated by the large photodiodes LPD of the pixel PX.

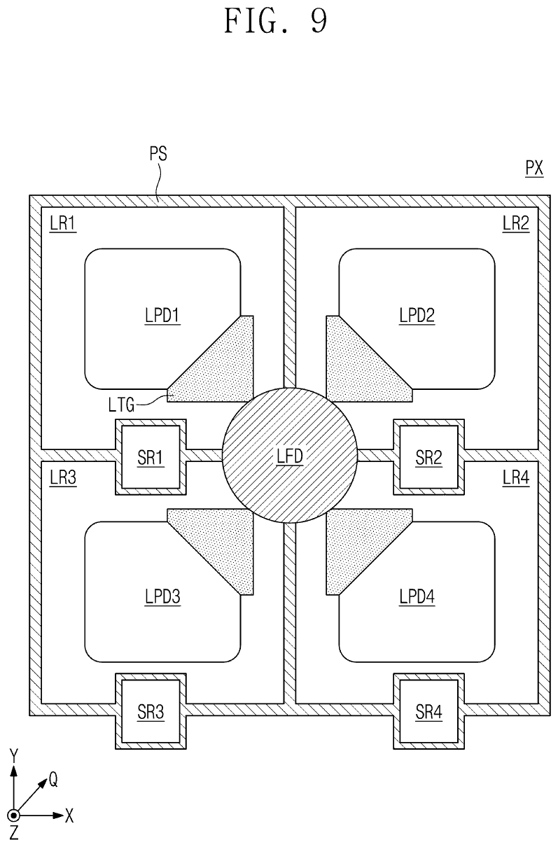

FIG. 9 is a diagram illustrating a layout of a pixel of FIG. 2. FIG. 9 will be described with reference to FIGS. 1 to 8B. Referring to FIG. 9, the pixel PX may include a pixel separation layer PS separating the first to fourth large sub-pixels LSPX1 to LSPX4 from the first to fourth small sub-pixels SSPX1 to SSPX4. The first to fourth large sub-pixels LSPX1 to LSPX4 and the first to fourth small sub-pixels SSPX1 to SSPX4 may be electrically separated or isolated through the pixel separation layer PS. In some embodiments, the pixel separation layer PS may be a deep trench isolation (DTI). In some embodiments, the pixel separation layer PS may be a back deep trench isolation (BDTI). In some embodiments, the pixel separation layer PS may be a front deep trench isolation (FDTI).

The pixel PX may be divided into first to fourth large regions LR1 to LR4 and first to fourth small regions SR1 to SR4 by the pixel separation layer PS. The first to fourth large sub-pixels LSPX1 to LSPX4 may be disposed in the first to fourth large regions LR1 to LR4. For example, the first large photodiode LPD1 may be disposed in the first large region LR1, the second large photodiode LPD2 may be disposed in the second large region LR2, the third large photodiode LPD3 may be disposed in the third large region LR3, and the fourth large photodiode LPD4 may be disposed in the fourth large region LR4.

The first to fourth small sub-pixels SSPX1 to SSPX4 may be disposed in the first to fourth small regions SR1 to SR4. For example, the small photodiode SPD, the small transfer gate STG, the small floating diffusion node SFD, the capacitor control transistor CCTR, and the switch SW of the first small sub-pixel SSPX1 may be disposed in the first small region SR1.

Meanwhile, the large floating diffusion node LFD may be disposed on a central portion of the pixel PX. According to some embodiments of the present disclosure, the large floating diffusion node LFD may not be separated or isolated by the pixel separation layer PS. That is, the pixel separation layer PS may include an open region, and the large floating diffusion node LFD may be disposed in the open region. That is, in some embodiments, the layout of the pixel PX may be implemented in a DTI center cut (DCC) structure. The large floating diffusion node LFD may be connected to the first to fourth large photodiodes LPD1 to LPD4 through the large transfer gates LTG. In some embodiments, the first to fourth large photodiodes LPD1 to LPD4 may be disposed outside a radial direction with respect to the center of the large floating diffusion node LFD (e.g., the first to fourth large photodiodes LPD1 to LPD4 are spaced apart from the center of the large floating diffusion node LFD in the radial direction).

Unlike the example illustrated in FIG. 9, the large floating diffusion node LFD may be separated or isolated by the pixel separation layer PS. In this case, the separated large floating diffusion nodes LFD may be electrically connected through a metal line or the like to implement the pixel PX of FIG. 2. In this case, the capacitance of the large floating diffusion node LFD may increase due to a parasitic capacitance of the metal line or the like. In this case, the conversion gain may decrease in the LPD-HCG binning readout operation LH-BRD, thereby causing the reduction of performance of the image sensor device 100. In contrast, in the case of the present disclosure, as the pixel PX is implemented in the DCC structure, the image sensor device 100 may perform the LPD-HCG binning readout operation LH-BRD without the reduction of performance.

That is, according to some embodiments of the present disclosure, the pixel PX including the sub-pixels SPX1 to SPX4 implemented in the split photodiode structure may be implemented in the DCC structure. Accordingly, the image sensor device 100 with improved performance may be provided.

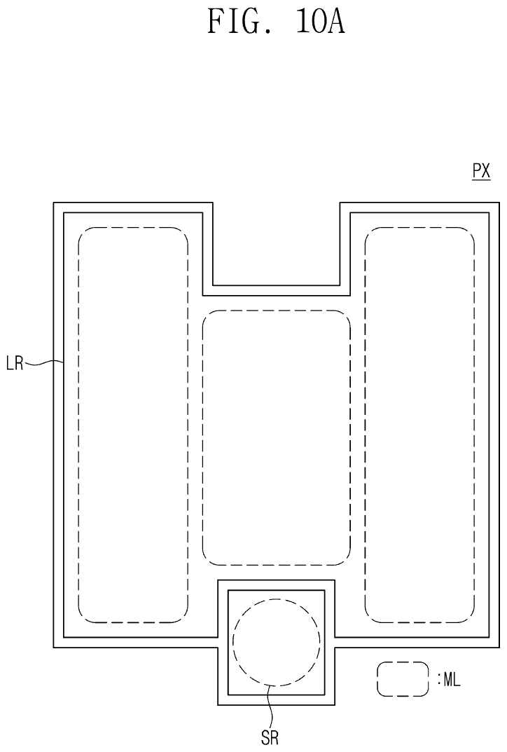

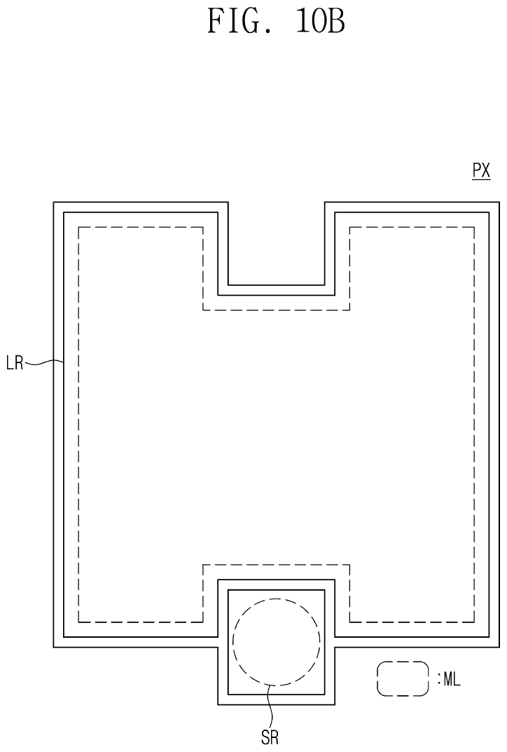

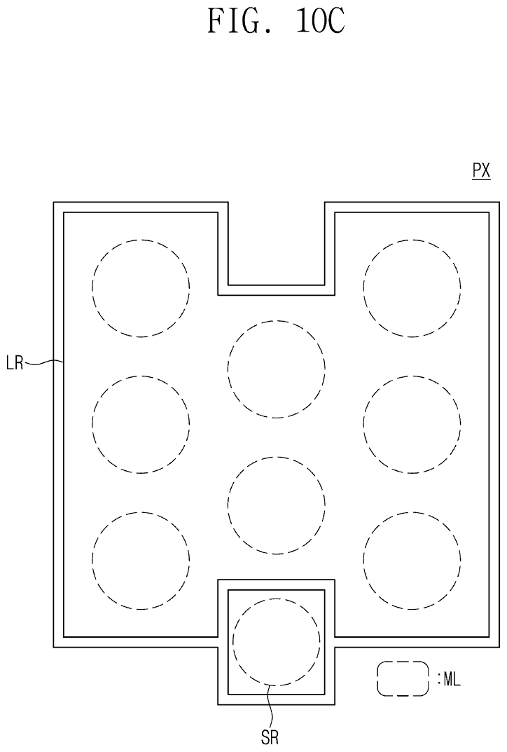

FIGS. 10A to 10C are diagrams for describing a micro lens of a pixel. Referring to FIGS. 10A to 10C, the pixel PX may include micro lenses ML collecting a light incident from the outside. In some embodiments, the micro lenses ML may include at least one micro lens corresponding to the large region LR and a micro lens corresponding to the small region SR.

For example, micro lenses corresponding to the large region LR may include a plurality of rectangular micro lenses ML as illustrated in FIG. 10A. Alternatively, micro lenses corresponding to the large region LR may include a plurality of circular micro lenses ML as illustrated in FIG. 10C. Also, for example, as illustrated in FIG. 10B, a micro lens corresponding to the large region LR may be one micro lens ML corresponding to the shape of the large region LR.

Meanwhile, a micro lens corresponding to the small region SR may be one circular micro lens ML. However, the present disclosure is not limited thereto. For example, the shape of the micro lens ML and the number of micro lenses ML may be variously changed or modified based on shapes of the large region LR and the small region SR.

FIGS. 11A and 11B are circuit diagrams for describing other examples of a unit pixel group of FIG. 2. Referring to FIG. 11A, the unit pixel group UPG may include 36 sub-pixels SPX arranged in the NONA pattern. The pixel PX of FIG. 11A may include first to third sub-pixels SPX1 to SPX3. The first sub-pixel SPX1 may include a first large sub-pixel LSPX1 and a first small sub-pixel SSPX1. The second sub-pixel SPX2 may include a second large sub-pixel LSPX2 and a second small sub-pixel SSPX2. The third sub-pixel SPX3 may include a third large sub-pixel LSPX3 and a third small sub-pixel SSPX3. Meanwhile, the first to third large sub-pixels LSPX1 to LSPX3 may share one large floating diffusion node LFD. The image sensor device 100 may perform the normal readout operation for each of the sub-pixels SPX1 to SPX3 and may then perform the binning readout operation based on the large sub-pixels LSPX1 to LSPX3. The pixel structure of FIG. 11A is similar to the pixel structure of FIG. 3, and thus, additional description will be omitted to avoid redundancy.

Referring to FIG. 11B, large sub-pixels LSPX1 to LSPX4 of a unit pixel group UPG having the tetra cell structure may be configured to share a large reset gate LRG and a gain control gate DRG. In this case, each of the large sub-pixels LSPX1 to LSPX4 may only include a large photodiode LPD and a large transfer gate LTG. The pixel structure of FIG. 11B is similar to the pixel structure of FIG. 3, and thus, additional description will be omitted to avoid redundancy.

Meanwhile, in some embodiments, the unit pixel group UPG may be implemented to include sub-pixels SPX arranged in a quadra pattern.

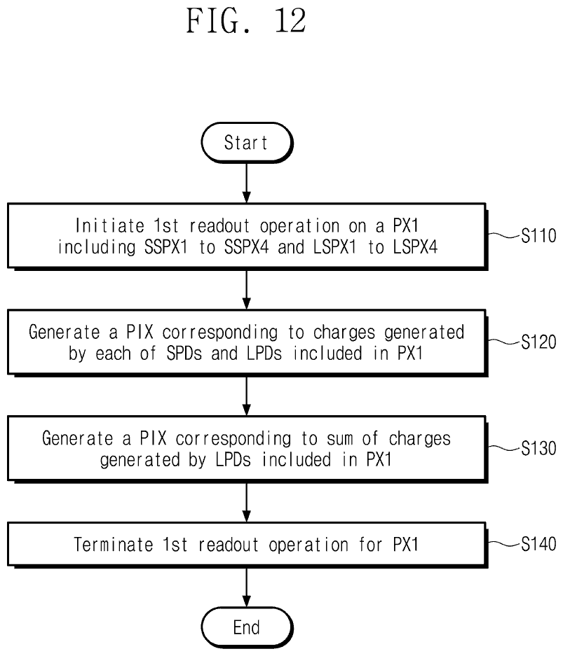

FIG. 12 is a diagram for describing an operation method of an image sensor device according to some embodiments of the present disclosure. FIG. 12 will be described with reference to FIGS. 1 to 11B. Referring to FIG. 12, in operation S110, the image sensor device 100 may initiate the execution of a first readout operation on a first pixel PX1 among a plurality of pixels of the pixel array 110. For example, the image sensor device 100 may turn on the select gate SG of the first pixel PX1 to initiate the execution of the first readout operation.

In operation S120, the image sensor device 100 may generate the pixel signals PIX respectively corresponding to the small photodiode SPD and the large photodiode LPD of the first pixel PX1. For example, the image sensor device 100 may generate the pixel signals PIX by performing the first to fourth normal readout operations NRD1 to NRD4 on the first to fourth sub-pixels SPX1 to SPX4 of the first pixel PX1.

In operation S130, the image sensor device 100 may generate the pixel signal PIX corresponding to a sum of charges generated by the large photodiodes LPD of the first pixel PX1. For example, the image sensor device 100 may generate the pixel signal PIX by performing the LPD-HCG binning readout operation LH-BRD on the first pixel PX1. While the LPD-HCG binning readout operation LH-BRD is performed, the first pixel PX1 may sequentially output the first binning pixel signal BPIX1 (refer to FIG. 5B) and the second binning pixel signal BPIX2 (refer to FIG. 5B) as the pixel signal PIX.

In operation S140, the image sensor device 100 may terminate the execution of the first readout operation on the first pixel PX1. For example, the image sensor device 100 may terminate the execution of the first readout operation by turning off the select gate SG of the first pixel PX1.

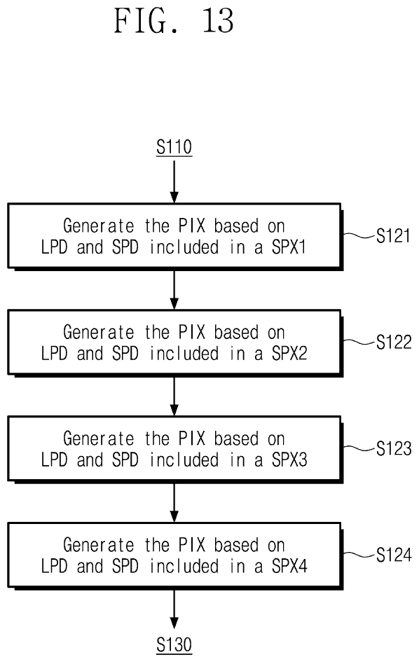

FIG. 13 is a diagram for describing operation S120 of FIG. 12 in detail. Referring to FIG. 12, in operation S121, the image sensor device 100 may generate the pixel signal PIX based on the large photodiode LPD and the small photodiode SPD of the first sub-pixel SPX1. In detail, the image sensor device 100 may perform the first normal readout operation NRD1 (refer to FIGS. 5A and 5B) on the first sub-pixel SPX1 of the first pixel PX1. While the first normal readout operation is performed, the first sub-pixel SPX1 may sequentially output the first to eighth normal pixel signals NPIX1 to NPIX8 (refer to FIG. 5B) as the pixel signal PIX.

In operation S122, the image sensor device 100 may generate the pixel signal PIX based on the large photodiode LPD and the small photodiode SPD of the second sub-pixel SPX2. In detail, the image sensor device 100 may perform the second normal readout operation NRD2 (refer to FIGS. 5A and 5B) on the second sub-pixel SPX2 of the first pixel PX1.

In operation S123, the image sensor device 100 may generate the pixel signal PIX based on the large photodiode LPD and the small photodiode SPD of the third sub-pixel SPX3. In detail, the image sensor device 100 may perform the third normal readout operation NRD3 (refer to FIGS. 5A and 5B) on the third sub-pixel SPX3 of the first pixel PX1.

In operation S124, the image sensor device 100 may generate the pixel signal PIX based on the large photodiode LPD and the small photodiode SPD of the fourth sub-pixel SPX4. In detail, the image sensor device 100 may perform the fourth normal readout operation NRD4 (refer to FIGS. 5A and 5B) on the fourth sub-pixel SPX4 of the first pixel PX1.

As described with reference to FIGS. 5A to 6B, as in the first normal readout operation NRD1, the image sensor device 100 may perform the second to fourth normal readout operations NRD2 to NRD4.

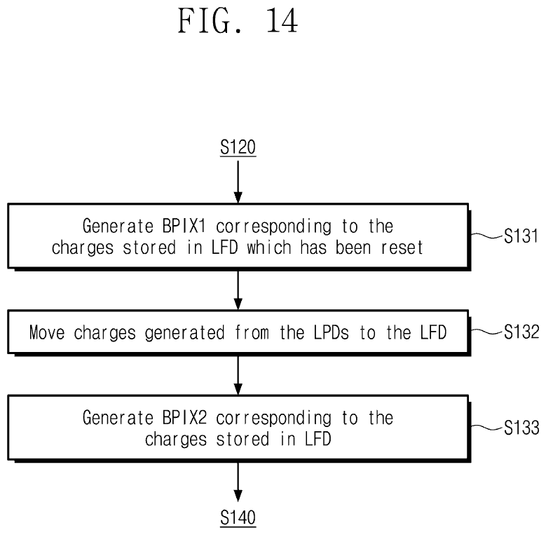

FIG. 14 is a diagram for describing operation S130 of FIG. 12 in detail. Referring to FIG. 14, in operation S131, the image sensor device 100 may generate the first binning pixel signal BPIX1 corresponding to the amount of charges stored at the reset large floating diffusion node LFD. That is, after the execution of the full-mode readout operation of FIG. 5A is completed, the image sensor device 100 may reset the large floating diffusion node LFD and may generate the first binning pixel signal BPIX1 corresponding to a voltage level of the large floating diffusion node LFD (i.e., corresponding to the amount of charges stored at the reset large floating diffusion node LFD).

In operation S132, the image sensor device 100 may transfer the charges generated by the large photodiodes LPD to the large floating diffusion node LFD. In detail, the image sensor device 100 may turn on the large transfer gates LTG of the first to fourth large sub-pixels LSPX1 to LSPX4 of the first pixel PX1. Accordingly, the charges generated by the large photodiodes LPD may be transferred to the large floating diffusion node LFD.

In operation S133, the image sensor device 100 may generate the second binning pixel signal BPIX2 corresponding to the amount of charges stored at the large floating diffusion node LFD. In this case, the second binning pixel signal BPIX2 may correspond to a sum of charges generated by the large photodiodes LPD.

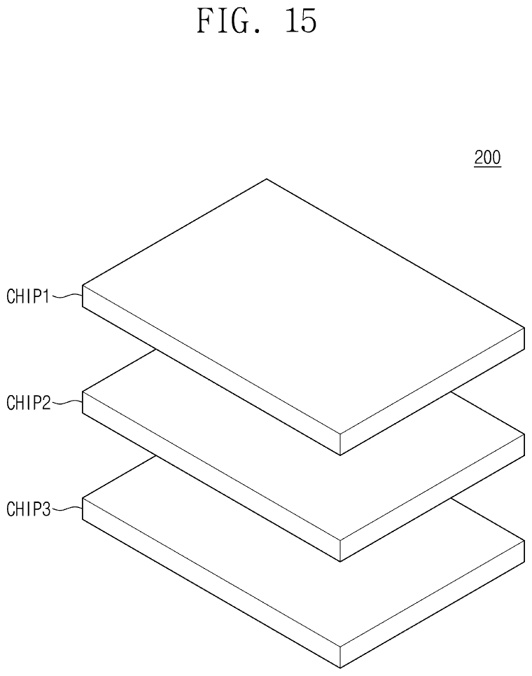

FIG. 15 is a diagram illustrating an image sensor device according to some embodiments of the present disclosure. Referring to FIG. 15, an image sensor device 200 may include a plurality of chips CHIP1 to CHIP3. In some embodiments, the image sensor device 200 may have a structure in which the plurality of chips CHIP1 to CHIP3 are stacked. Meanwhile, the image sensor device 20 of FIG. 15 may correspond to the image sensor device 100 of FIG. 2.

The first chip CHIP1 may include a pixel array included in the image sensor device 200. The second chip CHIP2 may include various analog circuits (e.g., an ADC, a row driver, and a ramp generator) used in the image sensor device 200. The third chip CHIP3 may include various digital circuits (e.g., a digital logic circuit and a memory circuit) used in the image sensor device 200. However, the present disclosure is not limited thereto. For example, components of the image sensor device 200 may be distributed and disposed in the first to third chips CHIP1 to CHIP3.

In some embodiments, the first to third chips CHIP1 to CHIP3 may be stacked based on various methods such as C2C bonding and a combination of a through-hole and a metal pad.

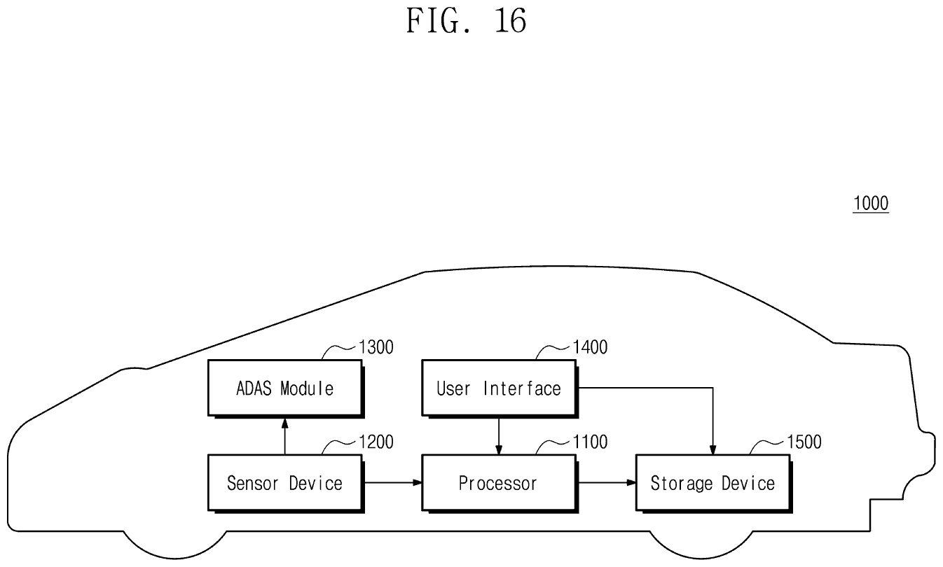

FIG. 16 is a diagram illustrating an autonomous driving system to which an image sensor device according to some embodiments of the present disclosure is applied. Referring to FIG. 16, an autonomous driving system 1000 may include a processor 1100, a sensor device 1200, an advanced driver assistance system (ADAS) module 1300, a user interface 1400, and a storage device 1500. In some embodiments, the autonomous driving system 1000 may be included in an automotive electronic system. The autonomous driving system 1000 may assist a driver such that driving of the vehicle is assisted, or may autonomously control driving of the vehicle without the intervention of the driver or with partial driver intervention.

The processor 1100 may control all the operations of the autonomous driving system 1000. The sensor device 1200 may be configured to sense various operation information or various sensing information of the autonomous driving system 1000. Alternatively, the sensor device 1200 may be configured to capture the front, rear, or side view of the autonomous driving system 1000 (or the vehicle mounted with the autonomous driving system 1000).

The ADAS module 1300 may control operations (e.g., a steering operation, a braking operation, and an acceleration operation) of the autonomous driving system 1000 based on the sensing information from the sensor device 1200. In some embodiments, the sensor device 1200 may include the image sensor device described with reference to FIGS. 1 to 15. That is, when the sensor device 1200 performs the readout operation on the pixel PX, the sensor device 1200 may perform the binning mode readout operation. The dynamic range of the sensor device 1200 may be increased. Accordingly, it may be easy to identify an obstacle located in a specific region of the front, rear, or side of the vehicle. Accordingly, the ADAS module 1300 may control the vehicle more accurately.

The user interface 1400 may provide information about the autonomous driving system 1000 to the driver or user or may receive information about the control of the autonomous driving system 1000 from the driver or user. For example, the user interface 1400 may be connected to an automotive control device such as a steering device, a braking device, an acceleration device, and a power device and may obtain various information provided from the driver through the automotive control device. Alternatively, the user interface 1400 may include a touch display panel that provides information about the autonomous driving system 1000 or the vehicle to the driver or receives information from the driver through the touch or operation of the driver.

The storage device 1500 may be configured to store information about the operation of the autonomous driving system 1000. In some embodiments, the storage device 1500 may be a data storage system for automated driving (DSSAD).

According to the present disclosure, an image sensor device may include a pixel array including a plurality of pixels. Each of the pixels of the pixel array may include a plurality of sub-pixels. Each of the plurality of sub-pixels may have a split photodiode structure. Also, large photodiodes included in one pixel may share a floating diffusion node. This may mean that the HDR of the image sensor device is easily implemented without increasing the pixel size. Accordingly, an image sensor device with improved performance and an operation method thereof are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An image sensor device comprising:
a first pixel electrically connected to a first column line, wherein the first pixel comprises:
a small reset gate electrically connected between a 0-th node and a reset power;
a first small sub-pixel, a second small sub-pixel, a third small sub-pixel, and a fourth small sub-pixel that are electrically connected to the 0-th node and respectively comprise small photodiodes;
a connect switch electrically connected between the 0-th node and a large floating diffusion node;
a first large sub-pixel, a second large sub-pixel, a third large sub-pixel, and a fourth large sub-pixel that are electrically connected to the large floating diffusion node and respectively comprise large photodiodes, wherein a light receiving area of each of the large photodiodes is greater than a light receiving area of each of the small photodiodes;
a source follower that is electrically connected between a pixel power and a first node and is configured to operate in response to a voltage of the large floating diffusion node; and
a select gate electrically connected between the first node and the first column line.

2. The image sensor device of claim 1, wherein each of the first large sub-pixel, the second large sub-pixel, the third large sub-pixel, and the fourth large sub-pixel is electrically connected to a ground power and further comprises:
a large transfer gate electrically connected between the large photodiode and the large floating diffusion node;
a gain control gate electrically connected to the large floating diffusion node and a second node; and
a large reset gate electrically connected to the second node and the reset power.

3. The image sensor device of claim 2, further comprising:
a row driver configured to generate control signals configured to control the first pixel,
wherein, during a first time interval, in response to the control signals, the connect switch is configured to be in a turn-off state, and the large transfer gates of the first large sub-pixel, the second large sub-pixel, the third large sub-pixel, and the fourth large sub-pixel are configured to be simultaneously turned on.

4. The image sensor device of claim 3, wherein, during the first time interval, the gain control gates of the first large sub-pixel, the second large sub-pixel, the third large sub-pixel, and the fourth large sub-pixel are configured to be turned on.

5. The image sensor device of claim 2, wherein:
the small photodiode of the each of the first small sub-pixel, the second small sub-pixel, the third small sub-pixel, and the fourth small sub-pixel and the first large sub-pixel, the second large sub-pixel, the third large sub-pixel, and the fourth large sub-pixel is electrically connected to the ground power; and
each of the first small sub-pixel, the second small sub-pixel, the third small sub-pixel, and the fourth small sub-pixel and the first large sub-pixel, the second large sub-pixel, the third large sub-pixel, and the fourth large sub-pixel further comprises:
a small transfer gate electrically connected between the small photodiode and a small floating diffusion node;
a capacitor control transistor electrically connected to the small floating diffusion node;
a first capacitor electrically connected to the capacitor control transistor and the pixel power; and
a switch electrically connected to the small floating diffusion node and the 0-th node.

6. The image sensor device of claim 1, wherein the first pixel further comprises:
a pixel separation layer that electrically separates the first small sub-pixel, the second small sub-pixel, the third small sub-pixel, and the fourth small sub-pixel and the first large sub-pixel, the second large sub-pixel, the third large sub-pixel, and the fourth large sub-pixel, respectively, and
wherein the large floating diffusion node is free of the pixel separation layer.

7. The image sensor device of claim 6, wherein the large photodiodes are spaced apart from a center of the large floating diffusion node in a radial direction.

8. The image sensor device of claim 6, wherein the first large sub-pixel is in a first region,
wherein the first small sub-pixel is in a second region that is separated from the second region by the pixel separation layer, and
wherein the first pixel further comprises:
a first micro lens corresponding to the first region; and
a second micro lens corresponding to the second region.

9. The image sensor device of claim 1, wherein the first pixel is configured to output a first pixel signal corresponding to a sum of charges provided from the large photodiodes to the first column line.

10. The image sensor device of claim 9, wherein, before the first pixel outputs the first pixel signal, the first pixel is configured to output second pixel signals corresponding to charges generated by the small photodiodes and the large photodiodes through the first column line.

11. The image sensor device of claim 10, wherein the second pixel signals further comprise:
a first normal pixel signal corresponding to a first set of the charges generated by the large photodiode of the first large sub-pixel in a first high conversion gain mode;
a second normal pixel signal corresponding to a second set of the charges generated by the large photodiode of the first large sub-pixel in a first low conversion gain mode;
a third normal pixel signal corresponding to a third set of the charges generated by the small photodiode of the first small sub-pixel in a second high conversion gain mode; and
a fourth normal pixel signal corresponding to a fourth set of the charges generated by the small photodiode of the first small sub-pixel in a second low conversion gain mode.

12. The image sensor device of claim 11, wherein the second pixel signals further comprise:
a fifth normal pixel signal corresponding to a fifth set of the charges generated by the large photodiode of the second large sub-pixel in the first high conversion gain mode;
a sixth normal pixel signal corresponding to a sixth set of the charges generated by the large photodiode of the second large sub-pixel in the first low conversion gain mode;
a seventh normal pixel signal corresponding to a seventh set of the charges generated by the small photodiode of the second small sub-pixel in the second high conversion gain mode; and
an eighth normal pixel signal corresponding to an eighth set of the charges generated by the small photodiode of the second small sub-pixel in the second low conversion gain mode.

13. An image sensor device comprising:
a first pixel electrically connected to a first sub-column line and a second sub-column line, wherein the first pixel comprises:
a small reset gate electrically connected between a 0-th node and a reset power;
a first small sub-pixel, a second small sub-pixel, a third small sub-pixel, and a fourth small sub-pixel that are electrically connected to the 0-th node and respectively comprise small photodiodes;
a small source follower that is electrically connected between a pixel power and a first node and is configured to operate in response to a voltage of the 0-th node;
a small select gate electrically connected between the first node and the first sub-column line;
a first large sub-pixel, a second large sub-pixel, a third large sub-pixel, and a fourth large sub-pixel that are electrically connected to a large floating diffusion node and respectively comprise large photodiodes, wherein a light receiving area of each of the large photodiodes is greater than a light receiving area of each of the small photodiodes;
a large source follower that is electrically connected between the pixel power and a second node and is configured to operate in response to a voltage of the large floating diffusion node; and
a large select gate electrically connected between the second node and the second sub-column line.

14. The image sensor device of claim 13, wherein the first pixel is configured to output a first large pixel signal corresponding to a sum of charges provided from the large photodiodes to the second sub-column line.

15. The image sensor device of claim 14, wherein, before the first pixel outputs the first large pixel signal, the first pixel is configured to:
output first small pixel signals corresponding to charges generated by the small photodiodes through the first sub-column line; and
output second large pixel signals corresponding to charges generated by the large photodiodes through the second sub-column line.

16. The image sensor device of claim 13, wherein each of the first large sub-pixel, the second large sub-pixel, the third large sub-pixel, and the fourth large sub-pixel is electrically connected to a ground power and further comprises:
a large transfer gate electrically connected between the large photodiode and the large floating diffusion node;
a gain control gate electrically connected to the large floating diffusion node and a third node; and
a large reset gate electrically connected to the third node and the reset power.

17. The image sensor device of claim 16, further comprising:
a row driver configured to generate control signals configured to control the first pixel,
wherein, during a first time interval, in response to the control signals, the large transfer gates of the first large sub-pixel, the second large sub-pixel, the third large sub-pixel, and the fourth large sub-pixel are simultaneously configured to be turned on.

18. The image sensor device of claim 17, wherein, during the first time interval, the gain control gates of the first large sub-pixel, the second large sub-pixel, the third large sub-pixel, and the fourth large sub-pixel are configured to be turned off in response to the control signals.

19. An operation method of an image sensor device which includes a first pixel including a plurality of small sub-pixels and a plurality of large sub-pixels sharing a large floating diffusion node, the method comprising:
generating first pixel signals corresponding to charges generated by small photodiodes of the plurality of small sub-pixels and large photodiodes of the plurality of large sub-pixels, wherein a light receiving area of the large photodiodes is greater than a light receiving area of the small photodiodes; and
generating a second pixel signal corresponding to a sum of charges generated by the large photodiodes.

20. The method of claim 19, wherein the generating of the second pixel signal further comprises:
transferring the charges generated from the large photodiodes to the large floating diffusion node in a high conversion gain mode.
